(19) United States
(12) Patent Application Publication
(10) Pub. No.: US 2017/0141385 A1
(43) Pub. Date: May 18, 2017

(54) LAYER COMPOSITE AND ELECTRODE HAVING A SMOOTH SURFACE, AND ASSOCIATED METHODS

(71) Applicants: Sion Power Corporation, Tucson, AZ (US); BASF SE, Ludwigshafen (DE)

(72) Inventors: Chariclea Scordilis-Kelley, Tucson, AZ (US); Zhaohui Liao, Tucson, AZ (US); Marina Safont-Sempere, Ludwigshafen (DE); Joern Kulisch, Eppelheim (DE); Holger Schneider, Ludwigshafen (DE); Klaus Leitner, Ludwigshafen (DE)

(73) Assignees: Sion Power Corporation, Tucson, AZ (US); BASF SE, Ludwigshafen (DE)

(21) Appl. No.: 15/343,890

(22) Filed: Nov. 4, 2016

Related U.S. Application Data
(60) Provisional application No. 62/250,962, filed on Nov. 4, 2015.

(51) Int. Cl. H01M 4/36; H01M 4/62; H01M 4/04

(52) U.S. Cl. CPC H01M 4/366; H01M 4/0402; H01M 4/624; H01M 2004/021

(57) ABSTRACT

Layer composites, electrodes comprising or consisting of said layer composites, electrochemical cells comprising said electrodes, and methods for forming said layer composites are generally described.

### RELATED APPLICATIONS

This application claims priority under 35 U.S.C. §119(e) to U.S. Provisional Patent Application Ser. No. 62/250,962, filed Nov. 4, 2015 and entitled “Layer Composite and Electrode Having a Smooth Surface, and Associated Methods,” which is incorporated herein by reference in its entirety for all purposes.

### TECHNICAL FIELD

Layer composites, electrodes comprising or consisting of said layer composites, electrochemical cells comprising said electrodes, and methods for forming said layer composites are generally described.

### BACKGROUND

The replacement of graphite intercalation anodes by metallic lithium anodes in current lithium ion battery systems is expected to increase the volumetric energy density by more than about 50% and the gravimetric energy density by about 45% upon full optimization of the system. Unfortunately, inhomogeneous (non-uniform) plating and stripping of lithium over the anode area during charging and discharging as well as limited Coulomb efficiency are serious drawbacks of these kinds of anodes. Inhomogeneous plating and stripping of lithium generally leads to formation of dendrites and generation of high surface area lithium. Dendrites generally lead to faster depletion of the electrolyte, thus reducing battery performance and cycle life. In the worst case, dendrite formation may result in a short circuit of a battery. In addition, side reactions between the metallic lithium and the liquid organic electrolyte generally lead to depletion of lithium and can lead to subsequent cell failure.

Several strategies have been reported to address this problem from the electrolyte point of view (e.g., use of ionic liquids, high salt concentrations, use of cations such as Cs or Rb, use of anions such as bis(fluorosulfonyl)imide (FSI) to reduce dendritic growth, use of solid polymer electrolytes at elevated temperatures). Furthermore, pretreatment of lithium anodes at different currents has been tested.

There remains a need for improved electrodes and electrochemical cells which address one or more of the problems described above.

### SUMMARY

Layer composites, electrodes comprising or consisting of said layer composites, electrochemical cells comprising said electrodes, and methods for forming said layer composites are generally described. According to certain embodiments, the layer composites comprise an external surface having a relatively low surface roughness. The subject matter of the present invention involves, in some cases, interrelated products, alternative solutions to a particular problem, and/or a plurality of different uses of one or more systems and/or articles.

Certain embodiments are related to layer composites. In some embodiments, the layer composite comprises a current collector; a base layer in contact with said current collector, said base layer comprising a particulate electroactive material; and a portion disposed on said base layer, wherein said portion comprises a functional material having a structure different from a structure of the particulate electroactive material in the base layer, said functional material being selected from the group consisting of electronically conducting materials, electroactive materials, and mixtures thereof. According to certain embodiments, said portion has an external surface facing away from the base layer, wherein the surface roughness Rz of said external surface of said portion is 5 μm or less.

Some embodiments are related to methods for forming layer composites. In certain embodiments, the method comprises disposing, on a base layer of a base structure comprising said base layer and a current collector in contact with said base layer, a portion comprising a functional material. In some such embodiments, said base layer comprises a particulate electroactive material. In certain such embodiments, said functional material of said portion comprises an electronically conducting material, an electroactive material, and/or one or more precursors of an electronically conducting material and/or an electroactive material. According to certain such embodiments, said functional material has a structure different from a structure of said particulate electroactive material in said base layer. In some such embodiments, said portion has an external surface facing away from said base layer, wherein a surface roughness Rz of said external surface of said portion is 5 μm or less.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic representation of a layer composite, according to certain embodiments;

FIG. 1B is, according to some embodiments, a schematic representation of a layer composite;

FIG. 1C is a schematic representation of a base structure of a layer composite according to FIG. 1B;

FIG. 1D is a schematic representation of a layer composite, according to certain embodiments;

FIG. 2 is a scanning electron microscope (SEM) cross sectional pictograph of a part of a layer composite according to certain embodiments;

FIG. 3 is a plot of roughness parameters of the external surfaces of layer composites and corresponding base structures, according to certain embodiments;

FIG. 4 is a series of conductive atomic force microscopy (AFM) images showing topography and distribution of electrically conducting areas of the surfaces of layer composites and corresponding base structures, according to certain embodiments;

FIG. 5 is a series of plots showing the current distribution along a distance of 80 μm on the external surfaces of layer composites and corresponding base structures, according to some embodiments;

FIG. 6A is an image of plated lithium on a copper foil, which served as a counter electrode for a cathode used in certain experimental tests;

FIG. 6B is an image of plated lithium on a copper foil, which served as a counter electrode for a cathode used in certain experimental tests;

FIG. 7 is a plot of the discharge capacity as a function of the cycle number for a comparison cell and cells according to certain embodiments;

FIG. 8 is a plot of accumulated discharge capacity at 80% of initial capacity for a comparison cell and cells according to certain embodiments;

FIG. 9 is a plot of rate capabilities (percentage capacity as a function of C-rate) of a comparison cell and cells according to certain embodiments;

FIG. 10 is a plot of roughness parameters of the external surfaces of further layer composites and the corresponding base structure, according to certain embodiments;

FIG. 11 is, according to certain embodiments, a series of SEM images of the external surfaces of further layer composites and the corresponding base structure;

FIG. 12 is a plot of the discharge capacity as a function of the cycle number for a comparison cell and further cells according to certain embodiments; and

FIG. 13 is a plot of rate capabilities (accumulated discharge capacity as a function of discharge current at the 15th discharge) of a comparison cell and further cells according to certain embodiments.

### DETAILED DESCRIPTION

Little attention has yet been paid to the influence of the cathode on the stripping/plating of lithium at the anode in lithium-based electrochemical cells. However, the morphology and current distribution of the cathode can have a remarkable influence on the morphology of the plated lithium, especially in certain electrochemical cells having lithium ion cathodes (releasing lithium ions during charging).

An important factor which may lead to a non-uniform current distribution is the presence of protruding areas (peaks) and recessed areas (valleys) at the electrode surface, which together generally define the surface roughness of the electrode surface. The peaks and valleys can, in some cases, arise from the particulate structure of the electroactive material, as the presence of discrete particles of electroactive material in the electrode structure can produce surface peaks and valleys. Due to the surface roughness of the electrode surfaces of such electrodes, the distance from the surface of the cathode to the surface of the anode can vary over the electrode area. This variation of the distance between the electrode surfaces can, in certain instances, result in an uneven thickness of the electrolyte layer between the electrodes.

Another factor which may lead to non-uniform current distribution is also related to the particulate structure of the electroactive material (e.g., the electroactive material of a lithium ion cathode). Electroactive materials often have a low electronic conductivity. Thus, in certain such cases, the particles of the electroactive material can form domains of low electronic conductivity. The dimensions of said domains generally depend on the particle size when particulate electroactive materials are employed. Thus, in some such cases, the larger the particle size of the electroactive material, the larger the domains of low conductivity, and the less uniform is the current distribution.

While one could consider employing electroactive material having smaller particle sizes, there are several limitations with regard to the use of small particle size electroactive material. Generally, the smaller the particle size, the higher the surface area/volume ratio of a particle. A very high surface area to volume ratio may promote adverse side reactions and reduce cycle life. Other potential disadvantages of electroactive materials having small particle size are related to diffusion problems, which can result in poor C rates and polarization problems. Moreover, the high tortuosity and high number of crystal boundaries in an electrode comprising an electroactive material of relatively small particle size can also be detrimental to electrode performance. Finally, in certain cases in which electroactive material of relatively small particle size is employed, the density and packing of the particles in the electrode can be too tight, such that electrolyte wetting of the electrode is impeded.

Moreover, in certain lithium anode-based systems in which a thin protective (e.g., ceramic) layer is disposed on top of the metallic lithium anode (e.g., in order to protect it from undesired side reactions with the electrolyte), proper morphology of the cathode can be important for at least two reasons. First, non-uniform current distribution at the cathode can lead to non-uniform plating of lithium underneath the protective layer of the anode so that, in certain cases, the protective layer becomes subject to tension, and there may arise the risk of rupture upon cycling. Second, a rough cathode surface could, under certain conditions (such as application of pressure), lead to mechanical damage of the protective layer and therefore failure of the battery system.

For at least the reasons outlined above, there is a need for electrodes having an improved morphology, especially in terms of surface roughness (e.g., as quantified using Rz) and distribution of electronically conducting domains at the electrode surface. Electrodes having a surface with a low roughness would be desirable. There is also a need for reducing the size and number of domains of low electronic conductivity at the electrode surface. There is also a need for a cathode having a morphology which allows for even and uniform plating and stripping of lithium at an anode cooperating with said cathode.

According to certain embodiments, there is provided a layer composite comprising a current collector, a base layer in contact with said current collector, said base layer comprising a particulate electroactive material, and a portion disposed on said base layer. In some such embodiments, said portion comprises a functional material having a structure different from the structure of the particulate electroactive material of the base layer, said functional material being selected from the group consisting of electronically conducting materials, electroactive materials, and mixtures of both. In some embodiments, said portion has an external surface facing away from the base layer, wherein the surface roughness Rz of said external surface is 5 μm or less. Electrodes, such as lithium ion cathodes, which comprise or consist of said composites, are also provided.

The layer composites described herein comprise, according to certain embodiments, a current collector, a base layer (described in more detail elsewhere herein), and a portion disposed on said base layer (also described in more detail elsewhere herein). In certain embodiments, the layer composite consists of a current collector, a base layer, and a portion disposed on said base layer. Said current collector, said base layer, and said portion disposed on said base layer are sometimes referred to herein as structural elements of a layer composite, according to certain embodiments.

The current collector can be any structural element which allows for the flow of electronic current toward and away from said base layer which is in contact with said current collector. Suitable constructions of current collectors are known to those of ordinary skill in the art.

The base layer is generally a structural element which is in contact with said current collector and comprises a particulate electroactive material. According to certain embodiments, the current collector and the base layer are present in the form of individual layers, with the base layer being disposed on the current collector. In other embodiments, the current collector is integrated into the bulk of the base layer. The entity of said current collector and said base layer is sometimes referred to herein as the base structure of a layer composite.

According to certain embodiments, the base layer further comprises one or more particulate electronically conducting material(s). The particulate electronically conducting material(s) can, according to certain embodiments, facilitate electron transfer between the current collector and the electroactive material.

The term “portion,” as used herein to describe a component of the layer composite, denotes a structural element which is disposed on the base layer (e.g., as described above) and comprises a functional material having a structure different from the structure of the particulate electroactive material of the base layer. (Further details of said functional material are described, for example, below). Said portion comprises, according to certain embodiments, at least one layer disposed on the base layer. In some such embodiments, said portion disposed on said base layer consists of a single layer disposed on said base layer (herein referred to as single layered portion). In certain embodiments, said portion disposed on said base layer comprises a first layer disposed on said base layer and one or more additional layers disposed on said first layer (multilayer portion) wherein at least one of said first layer and said one or more additional layers comprises said functional material. Said portion has, according to certain embodiments, an external surface facing away from the base layer, wherein the surface roughness Rz of said external surface of said portion is 5 μm or less, 4.5 μm or less, 4 μm or less, 3.5 μm or less, 3 μm or less, 2.5 μm or less, or 2 μm or less.

With regard to the thickness of the portion disposed on said base layer, it is important, according to some embodiments, that the rate capability of the cathode comprising or consisting of a layer composite is not substantially negatively affected, compared to a cathode of identical construction with the exception that it does not comprise the portion (as described, for example, above) disposed on the base layer. According to certain embodiments, the layer composite has a total thickness of 1 mm or less, 150 μm or less, or 100 μm or less. In some embodiments, the thickness of the portion (e.g., as described above) disposed on the base layer (e.g., as described above) is in the range of from 50 nm to 50 μm, from 100 nm to 10 μm, or from 3 μm to 5 μm.

Surprisingly, it has been found that, according to certain (although not necessarily all) embodiments, the rate capability of the cathode is not substantially negatively affected when the portion disposed on the base layer has a thickness falling in the above-defied ranges.

In some embodiments, said portion (e.g., as described above) disposed on the base layer (e.g., as described above) extends over the whole area of said base layer. In certain embodiments, said portion disposed on the base layer extends over a relatively large portion of the base layer (e.g., at least 50%, at least 75%, or at least 90% of the base layer), but not necessarily over the entire area of said base layer.

As described in more detail below, a variety of electroactive materials may be used. Suitable electroactive materials are generally those that can participate in an electrochemical reaction in which electrical energy is released during discharging. In certain cases, the electroactive material may be one suitable for use in a rechargeable electrochemical cell, in which case, the electroactive material can be any material that can participate in an electrochemical reaction in which electrical energy is stored during charging (i.e., feeding of electrical current) and in which electrical energy is released by reversal of the electrochemical reaction during discharging (i.e., withdrawal of electric current).

The term “particulate material” as used herein denotes a material in the form of a plurality of discrete individuated particles. Generally, the discrete individual particles are not fused or aggregated. However, it is not excluded that particles of a particulate material (e.g., particulate electroactive material(s) in the base layer and/or functional material(s) in the portion disposed on the base layer) simply contact one another at one or more surfaces.

The size of the particles of a particulate material (e.g., particulate electroactive material(s) in the base layer and/or functional material(s) in the portion disposed on the base layer) can be characterized by the “mean maximum cross-sectional dimension” of the particles of said particulate material. As used herein, the “maximum cross-sectional dimension” of a particle refers to the largest distance between two opposed boundaries of an individual particle that may be measured (e.g., the diameter). The “mean maximum cross-sectional dimension” of a plurality of particles refers to the number average of the maximum cross-sectional dimensions of the plurality of particles.

One of ordinary skill in the art would be capable of calculating the mean maximum cross-sectional dimension of the plurality of particles. For example, the maximum cross-sectional dimensions (as well as the minimum cross sectional dimensions, i.e., the smallest distance between two opposed boundaries of an individual particle) of individual particles may be determined through analysis of scanning electron microscope (SEM) images of the particles. For example, a cross-section of a structural element (e.g., a base layer as described above, portion disposed on the base layer as described above) of a layer composite at a depth halfway through the thickness of the component may be imaged using SEM. Through analysis of the resultant images, the mean maximum cross-sectional dimension of the particles of a particulate material (particulate electroactive materials in the base layer and functional materials in the portion disposed on the base layer) are determined. In certain cases, a backscatter detector and/or an energy-dispersive spectroscopy (EDS) detector may be used to facilitate identification of electroactive material particles and electronically conductive particles (e.g., as distinguished from particles of additives that may be present). The distribution of maximum cross-sectional dimensions and particle volumes could also be determined by one of ordinary skill in the art using SEM analysis. The mean maximum cross-sectional dimension of the plurality of particles is obtained by calculating the arithmetic mean of the maximum cross-sectional dimensions of the particles. The term “functional material” as used herein denotes a material selected from the group consisting of electronically conducting materials, electroactive materials, and mixtures of both. According to certain embodiments, said functional material in the portion disposed on the base layer has a structure that is different from the structure of the particulate electroactive material of the base layer.

The term “structure,” as used herein in the context of one material (e.g., functional material in the portion disposed on the base layer) having a structure that is different from the structure of another material (e.g., particulate electroactive material in the base layer), includes all parameters which describe the physical state, morphology, texture, and shape of a material. Said structural parameter of a material (e.g., particulate electroactive material as described above and/or functional material as described above) generally refers to the structure said material exhibits within a layer composite according to certain embodiments. In some cases this structure of a material in the composite layer (e.g., particulate electroactive material of the base layer and/or functional material of the portion disposed on the base layer) may remain substantially unchanged during forming said layer composite. For instance, when forming the base layer according to certain embodiments, a composition comprising said particulate electroactive material can be used, and the particulate electroactive material in the formed base layer can have substantially the same particle size and/or particle shape as the particulate electroactive material in said composition. Similarly, in certain cases where a composition (e.g., a slurry as described, for example, below) comprising said particulate functional material is used for forming the portion disposed on the base layer, the particulate functional material in the formed portion usually has substantially the same particle size and/or particle shape as the particulate functional material in said compositions. Generally, when compositions (e.g., slurries) comprising particulate materials (e.g., particulate electroactive material for the base layer, particulate functional material for the portion disposed on the base layer) are used for forming a layer composite according to certain embodiments, important structural parameters (e.g., particle size, particle shape) of said particulate materials remain substantially unchanged. Further details of suitable methods for forming a layer composite according to certain embodiments are described, for example, below.

In certain embodiments, a precursor of a functional material may be applied, said precursor having a structure different from the structure of the functional material in the formed layer composite.

According to certain embodiments, the functional material has a structure different from the structure of the particulate electroactive material of the base layer when said particulate electroactive material of the base layer and said functional material in the portion disposed on the base layer are different with regard to at least one structural parameter, e.g., particle size, particle shape, state of aggregation, degree of dispersion, crystal structure, etc.

According to some embodiments, the chemical composition of the functional material is selected from the group consisting of electronically conducting materials, electroactive materials, and mixtures of both. In certain embodiments, the functional material consists of one or more electronically conducting materials, or one or more electroactive materials, or a mixture of one or more electronically conductive materials and one or more electroactive materials. According to certain embodiments in which both electronically conductive material and electroactive material is present, the weight ratio between electronically conductive materials and electroactive materials is in the range of from 5:1 to 100:1, from 8:1 to 80:1, from 10:1 to 50:1, or from 15:1 to 30:1.

According to certain embodiments, the functional material consists of one or more electronically conductive materials. According to some embodiments, the functional material consists of a mixture of one or more electronically conductive materials and one or more electroactive materials. In some embodiments, the weight ratio between electronically conductive materials and electroactive materials is in the range of from 5:1 to 100:1, from 8:1 to 80:1, from 10:1 to 50:1, or from 15:1 to 30:1. According to certain, but not necessarily all, embodiments, employing functional materials having such compositions can provide a relatively even distribution of the electronic conductivity at the external surface of the portion disposed on the base layer.

For the sake of clarity, the term “structure of a material” as used herein does not include the chemical composition of said material (e.g., particulate electroactive material as described above and functional material as described above). In other words, in the context of the present specification, the chemical composition of a material is not a structural parameter of said material. Accordingly, in embodiments in which the functional material has a structure that is different from the structure of the particulate electroactive material of the base layer, it is not excluded that a particulate electroactive material of the base layer has the same chemical composition as a functional material of the portion disposed on the base layer (or, in case the functional material is a mixture, of a constituent of said functional material), provided that said particulate electroactive material of the base layer and said functional material of the portion disposed on the base layer are different with regard to at least one structural parameter. For instance, in such embodiments, the functional material may comprise or consist of an electroactive material which has the same chemical composition as the particulate electroactive material of the base layer, but has a smaller mean maximum cross-sectional dimension than the particulate electroactive material of the base layer.

According to certain embodiments, the electroactive material of the base layer is a particulate electroactive material, i.e., it is present in the form of a plurality of discrete individuated particles. The base layer comprises, according to some embodiments, a particulate electroactive material having a mean maximum cross-sectional dimension in the range of from 4 μm to 25 μm, or from 10 μm to 15 μm.

As explained above the particulate structure of the electroactive material of the base layer generally governs the morphology of said base layer. According to some embodiments, in the absence of said portion which has an external surface (facing away from the base layer) having a surface roughness Rz of 5 μm or less, the base layer has an external surface (facing away from the current collector) where the particulate electroactive material is exposed. Due to the particulate structure of the electroactive material, said external surface typically exhibits, according to certain embodiments, large domains wherein the electronic conductivity is low and/or which has a surface roughness Rz of more than 5 μm (for instance, 7 μm or more, 10 μm or more, 15 μm or more, or 20 μm or more).

According to certain embodiments, the portion disposed on the base layer can be fabricated such that the portion has an external surface facing away from the base layer that is not determined (or is determined only to a small degree) by the particulate structure of the electroactive material of the base layer. That is to say, in some cases, the portion disposed on the base layer can be fabricated such that the portion has an external surface facing away from the base layer that has low roughness and/or more uniform electronic conductivity, relative to the surface of the base layer on which the portion is deposited/formed. According to certain embodiments, proper selection of the structure of said functional material can create a surface facing away from the base layer which has a surface roughness Rz of 5 μm or less.

The surface roughness (Rz) (the mean peak to valley roughness (Rz)) as used herein is calculated by imaging the surface with a non-contact 3D optical microscope (e.g., an optical profiler). An image is acquired by scanning an area of 120 μm×95 μm at a magnification of 50×. The mean peak to valley roughness is determined by taking an average of the height difference between the five highest peaks and the five lowest valleys for a given sample size (averaging the height difference between the five highest peaks and the five lowest valleys across the imaged area of the sample) at several different locations on the sample (e.g., images acquired at five different areas on the sample).

There is a wide variety of structural parameters of a functional material which facilitate creation of an external surface having a surface roughness Rz of 5 μm or less.

One important structural parameter, according to certain embodiments, is the particle size. According to some embodiments, by selecting a particulate functional material which has a mean maximum cross-sectional dimension smaller than the mean maximum cross-sectional dimension of the particulate electroactive material of the base layer, voids and/or depressions at the external surface of the base layer can be at least partially filled. This can lead to an even, smooth topology which can facilitate creating an external surface having a surface roughness Rz of 5 μm or less. According to certain embodiments, a particulate functional material selected from the group consisting of (i) electronically conductive materials and (ii) mixtures of electronically conductive materials and electroactive materials, which have a smaller mean maximum cross-sectional dimension than the particulate electroactive material of the base layer, can allow for at least partial filling of voids and/or depressions at the surface of the base layer and/or reducing the dimensions of the domains of low electronic conductivity, which can create a smoother surface having a more uniform electronic conductivity.

According to certain embodiments, said functional material is a particulate functional material having a mean maximum cross-sectional dimension which is 50% or less, or 30% or less of the mean maximum cross-sectional dimension of the particulate electroactive material of the base layer.

Suitable ranges of the mean maximum cross-sectional dimension of the particulate electroactive material of the base layer are described, for example, above.

According to certain embodiments, said functional material is a particulate functional material having a mean maximum cross-sectional dimension in the range of from 30 nm to 4 μm, or from 100 nm to 1 μm. In some embodiments, the functional material has a mean maximum cross-sectional dimension of less than 1 μm (so-called nanoparticles or submicron particles).

In certain embodiments, said functional material is a particulate functional material having a mean maximum cross-sectional dimension which is 50% or less of the mean maximum cross-sectional dimension of the particulate electroactive material of the base layer wherein said particulate functional material has a mean maximum cross-sectional dimension in the range of from 30 nm to 4 μm.

According to some embodiments, said functional material is a particulate functional material having a mean maximum cross-sectional dimension which is 50% or less of the mean maximum cross-sectional dimension of the particulate electroactive material of the base layer, wherein the particulate electroactive material of the base layer has a mean maximum cross-sectional dimension in the range of from 4 μm to 25 μm.

In certain embodiments, said functional material is a particulate functional material having a mean maximum cross-sectional dimension which is 50% or less of the mean maximum cross-sectional dimension of the particulate electroactive material of the base layer, wherein the particulate electroactive material of the base layer has a mean maximum cross-sectional dimension in the range of from 4 μm to 25 μm and said particulate functional material has a mean maximum cross-sectional dimension in the range of from 30 nm to 4 μm.

Surprisingly, it has been found that, according to certain embodiments, when the functional material comprises a particulate electroactive material having a mean maximum cross-sectional dimension significantly smaller (e.g., 50% or less) than the mean maximum cross-sectional dimension of the particulate electroactive material of the base layer, side reactions which may be promoted by the high surface area/volume ratio of said small particles of electroactive material (see above) do not generally have a substantially adverse effect. Without wishing to be bound by any particular theory, it is believed that this may be due to the low thickness, according to some such embodiments, of the portion comprising said functional material, compared to the overall thickness of the layer composite. Thus, in certain embodiments of an electrode comprising or consisting of a layer composite, the fraction of electroactive material having a small particle size and accordingly a high surface area/volume ratio in said electrode can be low and therefore, in some such cases, does not substantially adversely affect the cycle life of the electrode.

Another important structural parameter, according to certain embodiments, is the shape of the particles of the functional material. In this regard, in some embodiments, the functional material comprises particles having a flat shape. In some such embodiments, the particulate electroactive material of the base layer comprises particles having a substantially spherical shape.

Particles having a substantially spherical shape, as used herein, are particles having a maximum cross-sectional dimension and a minimum cross-sectional dimension which differ by less than 25%. In some embodiments, the maximum cross-sectional dimension and the minimum cross-sectional dimension of the particles having a substantially spherical shape differ by less than 15% or less than 10%. The maximum cross-sectional dimension and the minimum cross-sectional dimension are determined as described above.

Particles having a “flat shape,” as used herein, are three-dimensional particles having a first external dimension (thickness) which is significantly smaller (50% or less) than second and third external dimensions (width, length), wherein the second and third external dimensions are substantially orthogonal (e.g., within 5°) to each other and to the first dimension. In the case of flat particles, the maximum cross-sectional dimension (as described above) substantially corresponds to the larger one of said second and third external dimensions, and the minimum cross-sectional dimension (as defined above) substantially corresponds to said third external dimension. In some embodiments, said particles have a mean minimum cross sectional dimension in the range of from 50 nm to 5 μm, or from 50 nm to 1 μm, and/or a mean maximum cross sectional dimension in the range of from 100 nm to 25 μm. Determination of the mean maximum cross-sectional dimension and the mean minimum cross sectional dimension are described above.

Non-limiting examples of flat particles are flakes and plate-like particles. A smooth external surface of the portion disposed on the base layer can be created, according to certain embodiments, by substantially parallel arrangement of the flat particles with regard to the external surface of said portion (e.g., when the second and third external dimensions (e.g., length and width) of said flat particles are parallel or substantially parallel (e.g., within 5° of parallel) to the external surface of the portion disposed on the base layer). In certain embodiments, the first, small external dimension (e.g., thickness) of said flat particles can be substantially perpendicular (e.g., within 5° of perpendicular) to the external surface of the portion disposed on the base layer.

Non-limiting examples of functional materials in the form of flat particles are graphite and graphene.

In some embodiments, said flat particles are particles of graphite or graphene and have a mean minimum cross-sectional dimension in the range of from 50 nm to 5 μm (or, in some embodiments, from 50 nm to 1 μm), and a mean maximum cross-sectional dimension in the range of from 100 nm to 25 μm.

The structure of the functional material is not limited to particulate functional materials, for example, as described above. According to certain embodiments, alternatives include:
a functional material which has a structure comprising fused particles
a functional material which has a monolithic structure
a functional material which has an aggregated structure
a functional material which has a polycrystalline structure.

The term “fused particles” as used herein generally refers to the physical joining of two or more particles such that they form a single particle. Those of ordinary skill in the art would understand that the term “fused” does not refer to particles that simply contact one another at one or more surfaces, but rather, refers to particles wherein at least part of the original surface of each individual particle can no longer be discerned from the other particle. According to certain embodiments, functional materials having a structure comprising fused particles are obtainable by aerosol deposition of a composition comprising suitable precursor particles.

A monolithic structure is generally a structure that does not exhibit grain boundaries and that is not made up of crystallites. In certain cases in which the functional material has a monolithic structure and the portion disposed on the base layer is a single layer portion, said single layer portion substantially consists of this monolithic structure functional material. In certain cases in which the functional material has a monolithic structure and the portion disposed on the base layer is a multi-layered portion, at least one layer of said multi-layered portion substantially consists of this monolithic structure functional material. In certain cases, said monolithic structure is amorphous (i.e., having no long-range order) or glassy.

Structures of functional materials wherein individual particles cannot be discerned, e.g., monolithic structures, are obtainable, for example, by vacuum deposition and/or plasma deposition. Since such functional materials do not exhibit a particulate structure, they have a structure which is different from the particulate structure of a particulate electroactive material that may be present in the base layer.

A polycrystalline structure as used herein denotes a structure which comprises crystallites held together by very thin layers of amorphous material.

According to certain embodiments, the functional material having a structure comprising fused particles, a monolithic structure, an aggregated structure, or a polycrystalline structure is an electronically conducting material.

As mentioned above, in a layer composite according to certain embodiments, said portion disposed on said base layer comprises at least one layer disposed on the base layer. Irrespective of the number of layers, it is important, according to certain embodiments, that said portion has an external surface facing away from the base layer, wherein the surface roughness Rz of said external surface of said portion is 5 μm or less. Suitable roughness ranges are described, for example, above.

In one set of embodiments, said portion disposed on said base layer consists of a single layer disposed on said base layer, said single layer comprising said functional material, wherein said single layer has an external surface facing away from the base layer, wherein the surface roughness Rz of said external surface is 5 μm or less. Examples of suitable roughness ranges are described, for example, above. In such embodiments, said portion consisting of a single layer disposed on said base layer is also referred to herein as a single layered portion. In some embodiments, said single layered portion has a thickness of in the range of from 50 nm to 50 μm. Additional suitable thickness ranges are described, for example, above.

According to certain embodiments, said functional material in said single layered portion consists of one or more electronically conducting materials, or one or more electroactive material, or a mixture of one or more electronically conductive materials and one or more electroactive materials. In some such embodiments in which the functional material is a mixture of one or more electronically conductive materials and one or more electroactive materials, the weight ratio between electronically conductive materials and electroactive materials is in the range of from 5:1 to 100:1, from 8:1 to 80:1, from 10:1 to 50:1, or from 15:1 to 30:1.

In certain embodiments, the functional material in said single layered portion consists of one or more electronically conducting materials, or a mixture of one or more electronically conductive materials and one or more electroactive materials. In some such embodiments in which the functional material in said single layered portion consists of a mixture of one or more electronically conductive materials and one or more electroactive materials, the weight ratio between electronically conductive materials and electroactive materials is in the range of from 5:1 to 100:1, from 8:1 to 80:1, from 10:1 to 50:1, or from 15:1 to 30:1. In some such embodiments, the use of such functional material can aid in providing a relatively even distribution of electronic conductivity.

According to some embodiments, said functional material in said single layered portion is a particulate functional material having a mean maximum cross-sectional dimension which is 50% or less of the mean maximum cross-sectional dimension of the particulate electroactive material of the base layer. Suitable mean maximum cross-sectional dimension ranges of the particulate electroactive material of the base layer are described, for example, above. In certain embodiments, said functional material is a particulate functional material having a mean maximum cross-sectional dimension in the range of from 30 nm to 4 μm. In some embodiments, the functional material has a mean maximum cross-sectional dimension of less than 1 μm (so-called nanoparticles or submicron particles). For further suitable ranges, reference is made to the disclosure given above.

In certain embodiments, said functional material in said single layered portion is a particulate functional material having a mean maximum cross-sectional dimension which is 50% or less of the mean maximum cross-sectional dimension of the particulate electroactive material of the base layer wherein said particulate functional material has a mean maximum cross-sectional dimension in the range of from 30 nm to 4 μm. Further suitable ranges are described, for example, above.

According to certain embodiments, said functional material in said single layered portion is a particulate functional material having a mean maximum cross-sectional dimension which is 50% or less of the mean maximum cross-sectional dimension of the particulate electroactive material of the base layer, wherein the particulate electroactive material of the base layer has a mean maximum cross-sectional dimension in the range of from 4 μm to 25 μm. Other suitable ranges are described, for example, above.

In certain embodiments, said functional material is a particulate functional material having a mean maximum cross-sectional dimension which is 50% or less of the mean maximum cross-sectional dimension of the particulate electroactive material of the base layer, wherein the particulate electroactive material of the base layer has a mean maximum cross-sectional dimension in the range of from 4 μm to 25 μm and said particulate functional material has a mean maximum cross-sectional dimension in the range of from 30 nm to 4 μm. Other suitable ranges are described, for example, above.

In some embodiments, said functional material is a particulate functional material having a mean maximum cross-sectional dimension which is 50% or less of the mean maximum cross-sectional dimension of the particulate electroactive material of the base layer (with suitable ranges of the particle size of the functional material of the single-layered portion and the particulate electroactive material of the base layer described, for example, above) wherein the functional material consists of one or more electronically conducting materials, or a mixture of one or more electronically conductive materials and one or more electroactive materials. In certain embodiments in which the functional material consists of a mixture of one or more electronically conductive materials and one or more electroactive materials, the weight ratio between electronically conductive materials and electroactive materials is in the range of from 5:1 to 100:1, from 8:1 to 80:1, from 10:1 to 50:1, or from 15:1 to 30:1.

In some embodiments, the functional material in said single layered portion is one of the following
a functional material which has a structure comprising fused particles
a functional material which has a monolithic structure
a functional material which has an aggregated structure
a functional material which has a polycrystalline structure.

In one set of embodiments, said portion disposed on said base layer comprises a first layer disposed on said base layer and one or more additional layers disposed on said first layer. In certain embodiments in which the portion comprises one or more additional layers, the layer which is most remote from the base layer has an external surface facing away from the base layer, wherein the surface roughness Rz of said external surface is 5 μm or less. Other suitable roughness ranges are described, for example, above.

In embodiments in which the portion comprises multiple layers, said portion comprising a first layer disposed on said base layer and one or more additional layers disposed on said first layer is generally referred to herein as a multi-layered portion. According to some such embodiments, in said multi-layered portion, at least one of said first layer and said one or more additional layers comprises a functional material. Suitable functional materials are described, for example, above with regard to suitable functional materials when the portion disposed on the base layer is a single layered portion, and elsewhere herein. According to certain embodiments, said functional material in said first layer is a particulate material having a mean maximum cross-sectional dimension which is 50% or less of the mean maximum cross-sectional dimension of the particulate material of the base layer.

In some embodiments, said first layer and at least one of said additional layers each comprise a functional material having a structure different from the structure of the particulate electroactive material of the base layer, wherein said functional materials differ from each other in structure and/or chemical composition.

According to certain embodiments, said multi-layered portion has a thickness in the range of from 50 nm to 50 μm. Other suitable thickness ranges are described, for example, above. According to some embodiments, in said multi-layered portion, the individual layers may have the same thicknesses, or the thicknesses may vary from layer to layer. For instance, according to certain embodiments, the layer thicknesses may decrease in the direction from the first layer disposed on the base layer to the layer which is most remote from the base layer.

In some embodiments, said multi-layered portion disposed on said base layer consists of a first layer disposed on said base layer and a second layer disposed on said first layer, wherein said second layer has an external surface facing away from the base layer, wherein the surface roughness Rz of said external surface is 5 μm or less. Other suitable roughness ranges are described, for example, above.

Said multi-layered portion consisting of a first layer disposed on said base layer and a second layer disposed on said first layer is generally referred to herein as a two-layered portion. In some embodiments, said two-layered portion has a thickness in the range of from 50 nm to 50 μm. Other suitable thickness ranges are described, for example, above. In said two-layered portion, the first and second layer may have the same thickness, or different thicknesses. In some embodiments, the first layer has a higher thickness than the second layer. In certain embodiments, the thickness of said second layer is 50% or less of a thickness of said first layer.

In said two-layered portion, according to certain embodiments, at least one of said first layer and said second layer comprises a functional material. Suitable functional materials are described, for example, above with regard to suitable functional materials when the portion disposed on the base layer is a single layered portion, and elsewhere herein. In some embodiments, the first layer comprises a functional material. In certain embodiments, said functional material is a particulate material having a mean maximum cross-sectional dimension which is 50% or less of the mean maximum cross-sectional dimension of the particulate material of the base layer.

According to certain embodiments, said first layer and said second layer each comprise a functional material having a structure different from the structure of the particulate electroactive material of the base layer, wherein said functional materials in said first and second layer of said two-layered portion differ from each other in structure and/or chemical composition.

In certain embodiments, said functional material in said first layer and said functional material in said second layer are particulate functional materials, wherein the particulate functional material in said second layer has a smaller mean maximum cross-sectional dimension than the particulate functional material in said second layer. Such gradual diminishing of the mean maximum cross-sectional dimension in the direction towards the external surface creates, according to certain embodiments, a particularly smooth external surface. In some embodiments, said functional material in said first layer is a particulate material having a mean maximum cross-sectional dimension which is 50% or less of the mean maximum cross-sectional dimension of the particulate material of the base layer and wherein said functional material in said second layer is a particulate material having a mean maximum cross-sectional dimension which is 50% or less of the mean maximum cross-sectional dimension of the particulate material of the first layer.

In certain embodiments, said functional material in said first layer is a particulate functional material having a mean maximum cross-sectional dimension which is 50% or less of the mean maximum cross-sectional dimension of the particulate material of the base layer and said functional material in said second layer has a structure selected from the group consisting of:
a structure comprising fused particles
a monolithic structure
aggregated structure, and
a polycrystalline structure.

In some such embodiments, the particles of the particulate functional material of the first layer of said portion at least partially fill voids and/or depressions of the base layer. This can lead to an even, smooth topology which can facilitate creating an external surface having a surface roughness Rz of 5 μm or less when a second layer comprising a non-particulate functional material is disposed on said first layer, since the non-particulate functional material of the second layer disposed on the first layer conforms to the smooth and even topology of the first layer. According to certain embodiments, the non-particulate functional material of the second layer is obtained by plasma deposition, vapor deposition, and/or aerosol deposition of a suitable composition on the first layer. In some embodiments, the non-particulate functional material is an electronically conducting material, and can, in certain cases, create a relatively uniform distribution of the electronic conductivity at the external surface. According to certain embodiments, the non-particulate functional material of said second layer is carbon. In some embodiments, the second layer comprises vacuum-deposited or plasma-deposited carbon. In certain embodiments, said functional material in said first layer has a structure selected from the group consisting of:
a structure comprising fused particles,
a monolithic structure,
an aggregated structure, and
a polycrystalline structure,

and said functional material in said second layer is a particulate material having a mean maximum cross-sectional dimension which is 50% or less of the mean maximum cross-sectional dimension of the particulate material of the base layer.

In some embodiments, said functional material in said first layer and said functional material in said second layer each have a structure selected from the group consisting of:
a structure comprising fused particles,
a monolithic structure,
an aggregated structure, and
a polycrystalline structure.

The electroactive material of the base layer is, according to certain embodiments, selected from the group of lithium ion cathode materials (releasing lithium ions upon charging and taking up lithium ions upon discharging). Also, in certain cases in which the functional material comprises or consists of one or more electroactive materials, said electroactive materials are, according to some embodiments, selected from the group of lithium ion cathode materials (releasing lithium ions upon charging and taking up lithium ions upon discharging).

According to certain embodiments, electroactive materials are selected from the group consisting of lithium iron phosphates, lithium nickel cobalt aluminum oxides, lithium manganese oxides, lithium nickel oxides, lithium cobalt oxides, lithium nickel manganese oxides, and lithium nickel cobalt manganese oxides.

In some embodiments, the particulate electroactive material of the base layer is selected from the group consisting of lithium iron phosphates, lithium nickel cobalt aluminum oxides, lithium manganese oxides, lithium nickel oxides, lithium cobalt oxides, lithium nickel manganese oxides, and lithium nickel cobalt manganese oxides.

In cases in which the functional material comprises or consists of one or more electroactive materials, said one or more electroactive materials are, according to certain embodiments, selected from the group consisting of lithium iron phosphates, lithium nickel cobalt aluminum oxides, lithium manganese oxides, lithium nickel oxides, lithium cobalt oxides, lithium nickel manganese oxides, and lithium nickel cobalt manganese oxides.

As explained above, according to certain embodiments, the functional material may comprise or consist of an electroactive material which has the same chemical composition as the particulate electroactive material of the base layer. In some such embodiments, said particulate electroactive material of the base layer and said functional material of the portion disposed on the base layer are different with regard to at least one structural parameter.

According to certain embodiments, electronically conducting materials are selected from the group consisting of graphite, graphene, carbon, and mixtures of two or more of graphite, graphene, and carbon.

The one or more electronically conducting materials of the base layer are, in some embodiments, selected from the group consisting of graphite, graphene, carbon, and mixtures of two or more of graphite, graphene, and carbon.

In embodiments in which the functional material comprises or consists of one or more electronically conducting materials, said one or more electronically conducting materials are, according to certain embodiments, selected from the group consisting of graphite, graphene, carbon, and mixtures of two or more of graphite, graphene, and carbon.

In certain embodiments, said base layer further comprises one or more binding agents.

In some embodiments, said portion disposed over the base layer further comprises one or more binding agents. One or more binding agents in the portion disposed over said base layer can be present, according to certain embodiments, when the functional material is a particulate functional material. In some such embodiments, in said portion, the weight ratio between the functional material and the binding agent is in the range of from 3:1 to 100:1, from 5:1 to 50:1, or from 10:1 to 20:1.

In certain embodiments, said base layer contains a binding agent, and said portion disposed over the base layer also contains a binding agent. The binding agent of the base layer and the binding agent of the portion disposed over the base layer can have the same chemical composition or different chemical compositions. In some embodiments, the complexity of the assembly process is reduced when the binding agent of the base layer and the binding agent of the portion disposed over the base layer have the same chemical composition.

According to certain embodiments, said binding agents are selected from the group consisting of polyvinylidene fluoride, styrene butadiene rubber, and carboxymethylcellulose, and poly(acrylic acid).

In certain embodiments in which the functional material in a single layered portion disposed on the base layer is one of the following:
a functional material which has a structure comprising fused particles,
a functional material which has a monolithic structure,
a functional material which has an aggregated structure, and
a functional material has a polycrystalline structure,

said single layered portion does not comprise a binding agent.

In certain embodiments in which the functional material in one or more layers of a multilayered portion disposed on the base layer is one of the following:
a functional material which has a structure comprising fused particles
a functional material which has a monolithic structure
a functional material which has an aggregated structure
a functional material which has a polycrystalline structure,

said layer(s) of said multi-layered portion do not comprise a binding agent.

Any suitable current collector may be used. In some embodiments, the current collector comprises or consists of at least one electronically conducting material, such as a metal (e.g., aluminum, copper, chromium, stainless steel, nickel, and/or combinations of two or more of these) or carbon fibers. In some embodiments, the current collector comprises or consists of a metal foil, such an aluminum foil. Such current collectors can, in some but not necessarily all embodiments, be advantageous when the electroactive material is selected from the group of lithium ion cathode materials (releasing lithium ions upon charging and taking up lithium ions upon discharging). In some embodiments, the current collector has a structure including openings, e.g., in a current collector in the form of a carbon fiber mat or of a metal grid. In some such embodiments, said structure is integrated in the bulk of the base layer. Contact (mechanical adhesion as well as electronic contact) between the base layer and the current collector may be facilitated, for example, by a coating comprising one or more electronically conductive materials (as described, for example, above) disposed at the interface between the current collector and the base layer.

According to certain embodiments, the layer composite is in the form of a tape. According to some embodiments, said tape is rollable. The use of a rollable tape can, according to certain embodiments, facilitate processing and/or storage.

According to some embodiments, the layer composite is in the form of a sheet. In some embodiments, said sheet has dimensions (e.g., thickness, length, and/or width) conforming to the dimensions of an electrode comprising or consisting of the layer composite.

A layer composite in the form of a sheet can be obtained, according to certain embodiments, by cutting a piece having the desired length and width from a layer composite in the form of a tape.

In a further aspect, certain embodiments relate to an electrochemical cell comprising an electrode comprising or consisting of a layer composite (e.g., according to any of the embodiments described above or elsewhere herein). Suitable features of said layer composite are described, for example, above and elsewhere herein. An electrochemical cell, according to certain embodiments, comprises an electrode comprising or consisting of a layer composite and a second electrode, the electrodes being separated by an electrolyte (e.g., an electrolyte layer). Suitable constructions of the second electrode and said electrolyte are known to those of ordinary skill in the art.

According to certain embodiments, the electrode comprising or consisting of the layer composite is the cathode of the electrochemical cell, and the second electrode is the anode. As used herein, “cathode” refers to the electrode in which an electroactive material is oxidized during charging and reduced during discharging, and “anode” refers to the electrode in which an electroactive material is reduced during charging and oxidized during discharging.

According to certain embodiments, the electrochemical cell comprises a second electrode comprising lithium metal and/or a lithium alloy. Combining—in an electrochemical cell—an electrode comprising lithium metal and/or a lithium alloy with an electrode comprising or consisting of a layer composite according to certain embodiments can, in certain cases, result in improved uniformity of plating and/or stripping of lithium at said electrode comprising lithium metal and/or a lithium alloy, and/or suppressed dendrite formation.

In a further aspect, certain embodiments relate to a method for forming a layer composite. According to certain embodiments, said method comprises the step of

forming on a base structure comprising a current collector and a base layer in contact with said current collector, said base layer comprising a particulate electroactive material

a portion disposed on said base layer wherein said portion has an external surface facing away from the base layer, wherein the surface roughness Rz of said external surface is 5 μm or less, wherein forming said portion comprises:

disposing on said base layer one or more compositions comprising a functional material having a structure different from the structure of the particulate electroactive material in the base layer, said functional material being selected from the group consisting of electronically conducting materials and electroactive materials and mixtures thereof, or one or more precursors of said functional material.

The base structure can be prepared or provided by any suitable method. For example, in some embodiments, the base structure can be formed by depositing an electroactive material (optionally with an electronically conductive material and/or a binding agent) on a current collector (e.g., a metal foil such as an aluminum foil). As another example, the base structure can be formed by depositing an electroactive material (optionally with an electronically conductive material and/or a binding agent) within the openings (e.g., pores) of a current collector having a structure including openings (e.g., a porous structure), such as a metal grid of a carbon fiber mat, such that the current collector is integrated into the bulk of the base structure. Contact (mechanical adhesion as well as electronic contact) between the base layer and the current collector may be facilitated, according to certain embodiments, by a coating comprising one or more electronically conductive materials (e.g., as described above) disposed at the interface between the current collector and the base layer. Other suitable methods for preparing or providing a suitable base structure are known to those of ordinary skill in the art.

Said base layer of said base structure has, according to certain embodiments, an external surface facing away from the current collector. The external surface of the base structure facing away from the current collector can expose the particulate electroactive material of the base layer. In certain cases the surface roughness Rz of said external surface of the base layer of the base structure is more than 5 μm (e.g., 7 μm or more, 10 μm or more, 15 μm or more, or 20 μm or more). In some embodiments, said composition comprising a functional material is disposed on said external surface of the base layer of the base structure.

In certain cases, said external surface of said base layer of the base structure exhibits voids and/or depressions, and disposing at least one composition comprising said functional material on said surface of said base layer comprises at least partially filling said voids and/or depressions on said external surface of said base layer. In some embodiments, said voids and/or depressions are substantially filled by disposing said at least one composition on said external surface of said base layer.

In some embodiments, at least one of said compositions is a slurry comprising said functional material (e.g., a particulate functional material). In some embodiments, said slurry further comprises a carrier liquid. Suitable carrier liquids include, but are not limited to, carrier liquids selected from the group consisting of water, N-methypyrrolidone, and N-ethylpyrollidone. In certain cases, said slurry further comprises one or more binding agents or precursors thereof.

In certain embodiments in which a composition (e.g. a slurry) comprising said particulate functional material is used for forming the portion disposed on the base layer, the particulate functional material in the formed portion has substantially the same particle size and/or particle shape as the particulate functional material in said compositions. Generally, when compositions (e.g. slurries) comprising particulate materials (particulate electroactive material for the base layer, particulate functional material for the portion disposed on the base layer) are used for forming a layer composite according to certain embodiments, important structural parameters (particle size, particle shape) of said particulate materials remain substantially unchanged.

Suitable particulate functional materials for preparing said composition (e.g., a slurry) can be identified, for example, by determining the average particle size by means of laser diffraction. Said method is known to those of ordinary skill in the art. Suitable particulate functional materials for preparing said composition (especially a slurry) can also be identified, for example, by determining the mean maximum cross-sectional dimension and, if appropriate, the mean minimum cross sectional dimension of said functional materials through analysis of scanning electron microscope (SEM) images of the particles and by calculating of the arithmetic mean of the maximum cross-sectional dimensions of the particles and, if appropriate, the minimum cross sectional dimensions of the particles.

According to certain embodiments, said functional material of said slurry is a particulate functional material having an average particle size in the range of from 30 nm to 4 μm as determined by laser diffraction. In some embodiments, the functional material has an average particle size of less than 1 μm (so-called nanoparticles or submicron particles). Other suitable ranges, including those described above, are also possible.

According to certain embodiments, said functional material is a particulate functional material having an average particle size which is 50% or less of the average particle size of the particulate electroactive material of the base layer, wherein said particulate functional material has average particle size in the range of from 30 nm to 4 μm as determined by laser diffraction. Other suitable ranges are described, for example, above.

In some embodiments, said functional material is a particulate functional material having an average particle size which is 50% or less of the average particle size of the particulate electroactive material of the base layer, wherein the particulate electroactive material of the base layer has an average particle size in the range of from 4 μm to 25 μm determined by laser diffraction. Other suitable ranges are described, for example, above.

According to certain embodiments, said functional material is a particulate functional material having an average particle size which is 50% or less of the average particle size of the particulate electroactive material of the base layer, wherein the particulate electroactive material of the base layer has an average particle size in the range of from 4 μm to 25 μm determined by laser diffraction and said particulate functional material has an average particle size in the range of from 30 nm to 4 μm as determined by laser diffraction. Other suitable ranges are described, for example, above.

In certain embodiments, at least one of said compositions is disposed on said base layer by plasma deposition, vapor deposition, and/or aerosol deposition. These methods are known to those of ordinary skill in the art.

According to certain embodiments, forming said portion on said base layer comprises disposing on said base layer one composition comprising a functional material, wherein said composition is a slurry comprising said functional material (e.g., a particulate functional material). This method can be used, according to certain embodiments, for forming of a single-layered portion on said base layer.

In some embodiments, forming said portion on said base layer comprises sequentially disposing on said base layer at least a first composition and a second composition each comprising a functional material, wherein said functional materials in said first composition and said second composition differ from each other in structure and/or chemical composition. According to some such embodiments, such methods can allow for forming of a multi-layered portion on said base layer (e.g., a two-layered portion, as described above). According to certain embodiments, forming the first layer of said two-layered portion comprises disposing said first composition on the external surface of the base layer of the base structure and forming a first layer disposed on said base layer of said base structure. Forming the second layer of said two-layered portion comprises, according to certain embodiments, disposing said second composition on said first layer formed from said first composition.

In some embodiments, said first composition is a first slurry comprising a first functional material and said second composition is a second slurry comprising a second functional material, wherein said functional materials in said first composition and said second composition differ from each other in structure and/or chemical composition

In certain embodiments, said first composition is a slurry comprising a particulate functional material, and said second composition is disposed by plasma deposition, vapor deposition, and/or aerosol deposition. In some such embodiments, the particles of the particulate functional material of the slurry at least partially fill voids and/or depressions at the external surface of the base layer. This can lead, according to certain embodiments, to an even, smooth topology which can facilitate creating a portion having an external surface having a surface roughness Rz of 5 μm or less when a second composition is disposed by plasma deposition, vapor deposition, and/or aerosol deposition. In some embodiments, the second layer disposed by plasma deposition, vapor deposition, and/or aerosol deposition conforms to the smooth and even topology of the first layer. According to certain embodiments, the functional material of said second layer is an electronically conductive material (e.g., carbon).

In some embodiments, said first composition is disposed by plasma deposition, vapor deposition, and/or aerosol deposition, and said second composition is a slurry comprising a particulate functional material. In some embodiments, said first composition is disposed by plasma deposition, vapor deposition, and/or aerosol deposition, and said second composition is disposed by plasma deposition, vapor deposition, and/or aerosol deposition.

According to certain embodiments, forming said portion disposed on said base layer comprises drying one or more of said compositions. This is especially the case when, for example, the composition comprises a carrier liquid. In some such embodiments, said carrier liquid is at least partially removed by drying. In some embodiments, at least 50%, at least 75%, at least 90%, at least 95%, at least 98%, at least 99%, or all of said carrier liquid is removed by drying.

In some embodiments, forming said portion disposed on said base layer comprises applying to one or more of said compositions disposed on said base layer a force in a range of 1 N/mm to 600 N/mm, or 200 N/mm to 300 N/mm. The force can be applied, according to certain embodiments, at a temperature in a range of 20° C. to 180° C., or 60° C. to 120° C. Suitable techniques for applying said force are known to those of ordinary skill in the art. According to certain embodiments, applying said force is carried out by calandering.

In certain embodiments in which the functional material comprises flat particles (as described above), the application of force (e.g., calandering) can produce a substantially parallel arrangement of the flat particles with regard to the external surface of said portion (e.g., when the second and third, relatively large external dimensions (e.g., length and width) of said flat particles are parallel or substantially parallel (e.g., within 5° of parallel) to the external surface of the portion disposed on the base layer.

According to certain embodiments, after (e.g., immediately after) disposing on a base layer of a base structure a composition comprising a functional material comprising flat particles, an external surface is created which may have a surface roughness Rz of more than 5 μm, for example, due to random orientation of the flat particles. According to certain embodiments, during calendaring, the flat particles adopt a substantially uniform orientation with their large two external dimensions (e.g., length and width) extending parallel or substantially parallel (e.g., within 5° of parallel) to the external surface of the portion disposed on the base layer and their small external dimension (e.g. thickness) extending substantially perpendicular (e.g., within 5° of perpendicular) to the base coating and current collector, which can result in a very smooth and uniform coating.

Application of force leads, according to certain embodiments, to a reduction of the thickness of the composition(s) disposed on said base layer. In some embodiments, the application of a force results in the formation of a portion disposed on the base layer (e.g., formed from a slurry) having a thickness in the range of from 50 nm to 50 μm. Other suitable ranges are described, for example, above.

In certain embodiments said precursor is in the form of a tape, and disposing said one or more compositions is carried out in a reel-to-reel mode.

In some embodiments, a method for forming a layer composite, comprises

disposing, on a base layer of a precursor comprising said base layer and a current collector in contact with said base layer, a portion comprising a functional material, wherein:

said base layer comprises a particulate electroactive material;

said functional material of said portion comprises an electronically conducting material and/or an electroactive material;

said functional material has a structure different from a structure of said particulate electroactive material in said base layer; and

said portion has an external surface facing away from said base layer, wherein a surface roughness Rz of said external surface of said portion is 5 μm or less.

According to certain embodiments, the layer composite obtained by the method is one of the above-described layer composites.

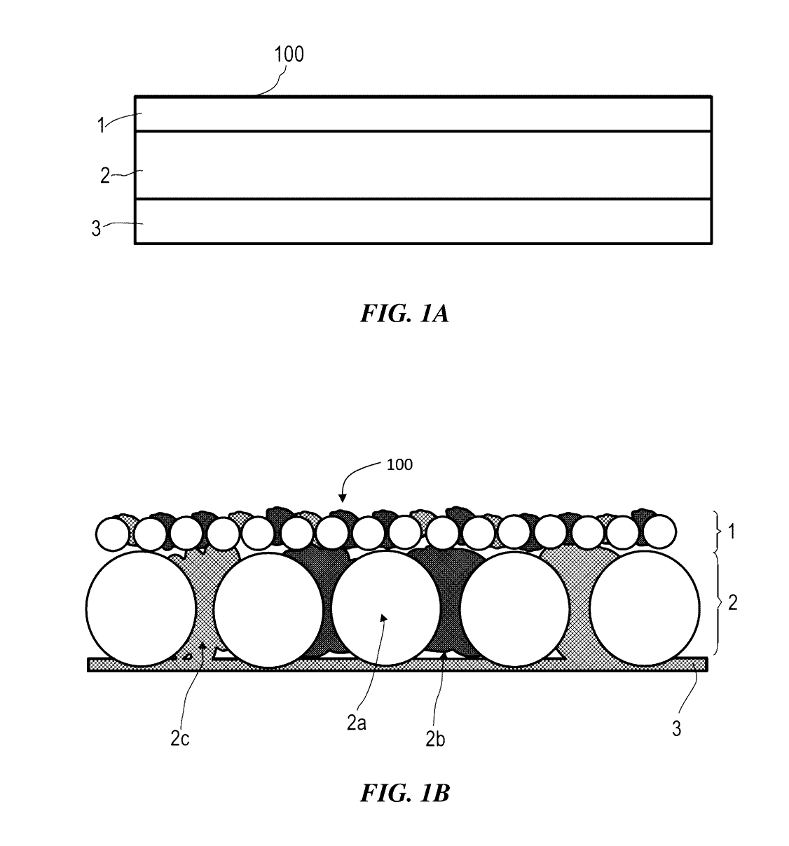

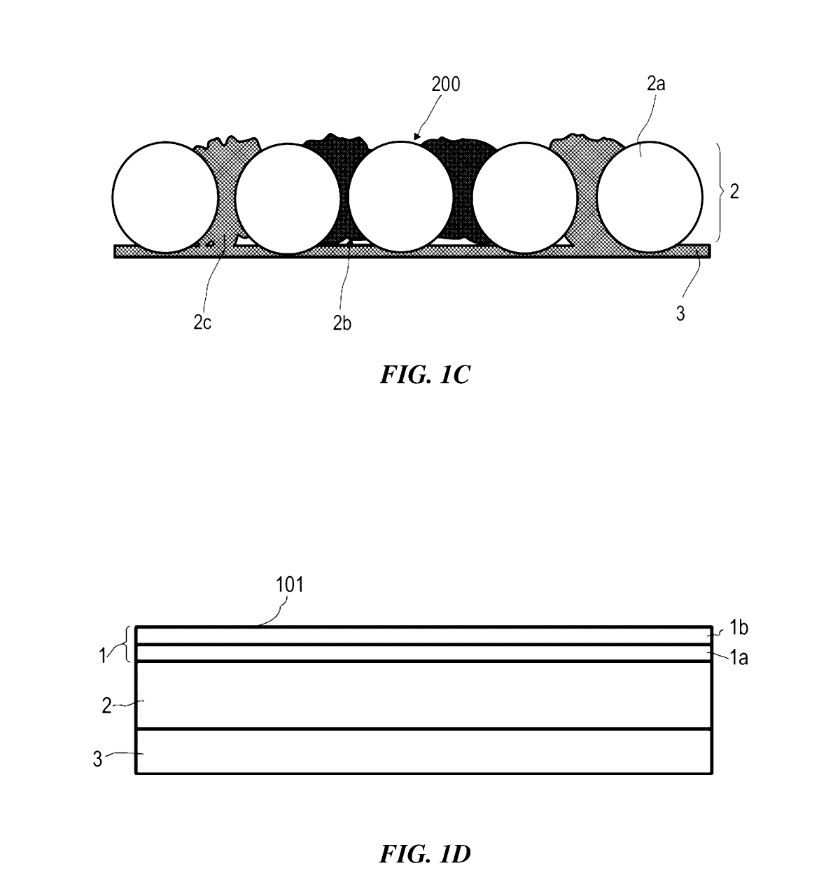

FIG. 1A shows a layer composite, according to certain embodiments. In FIG. 1A, the layer composite comprises current collector 3. The layer composite of FIG. 1A also comprises base layer 2 in contact with current collector 3. Base layer 2 can comprise a particulate electroactive material (not shown in the figure for purposes of clarity). The layer composite of FIG. 1A can also comprise portion 1 disposed on said base layer. According to certain embodiments, portion 1 consists of a single layer (single-layered portion) disposed on said base layer, as illustrated in FIG. 1A. Of course, as described above, portion 1 could also include multiple layers. Referring back to FIG. 1A, portion 1 has an external surface 100 facing away from base layer 2. In some embodiments, the surface roughness Rz of external surface 100 of portion 1 is 5 μm or less. Said single-layered portion 1 of FIG. 1A comprises a functional material (not shown in FIG. 1A, for purposes of clarity). Suitable functional materials are described, for example, above.

FIG. 1B shows another layer composite, according to certain embodiments. In FIG. 1B, the layer composite comprises current collector 3. The layer composite of FIG. 1B also comprises base layer 2 in contact with current collector 3. Base layer 2 also comprises a particulate electroactive material 2a. Base layer 2 also comprises an electronically conductive material 2b, which can facilitate electron transfer between current collector 3 and electroactive material 2a. Also illustrated in base layer 2 of FIG. 1B is binding agent 2c. Binding agent 2c can bind the particulate electroactive material 2a within said base layer. The layer composite of FIG. 1B also comprises portion 1 disposed on base layer 2. In FIG. 1B, portion 1 consists of a single layer (a single-layered portion) disposed on base layer 2. In FIG. 1B, portion 1 has an external surface 100 facing away from base layer 2. In some embodiments, as described above, the surface roughness Rz of said external surface 100 is 5 μm or less. In FIG. 1B, said single-layered portion 1 comprises a functional material in the form of a particulate electroactive material 1a admixed with an electronically conductive material 1b. The electronically conductive material can impart electronic conductivity to external surface 100. Single-layered portion 1 also comprises, in FIG. 1B, binding agent 1c, which can bind the particulate electroactive material 1a within said portion 1.

FIG. 1C shows the base structure of the layer composite according to FIG. 1B. The base structure in FIG. 1C comprises current collector 3. The base structure in FIG. 1C further comprises base layer 2 in contact with the current collector. The base layer comprises, in FIG. 1C, a particulate electroactive material 2a, an electronically conductive material 2b (which can facilitate electron transfer between the current collector 3 and the electroactive material 2b) and a binding agent 2c (which can bind the particulate electroactive material 2a within said base layer). In FIG. 1C, base layer 2 has an external surface 200 facing away from the current collector 3. In some embodiments, the surface roughness Rz of external surface 200 is more than 5 μm (e.g., 7 μm or more).

In some embodiments, particulate electroactive material 1a of portion 1 has a mean maximum cross-sectional dimension which is less than 50% of the mean maximum cross-sectional dimension of particulate electroactive material 2a of base layer 2. The particle size of the electroactive material in the base layer is, according to certain embodiments, governed by the constraints and requirements explained above. In some embodiments, particulate electroactive material 2a of base layer 2 has a mean maximum cross-sectional dimension in the range of from 4 μm to 25 μm, or from 10 μm to 15 μm. In certain embodiments, particulate electroactive material 1a of portion 1 has a mean maximum cross-sectional dimension in the range of from 30 nm to 4 μm, or from 100 nm to 1 μm. According to certain embodiments, particulate electroactive material 1a has a mean maximum cross-sectional dimension of less than 1 μm (so-called nanoparticles or submicron particles).

As can be seen from FIG. 1C, due to the large mean maximum cross-sectional dimension of electroactive material 2a of base layer 2, said base layer 2 comprises relatively large domains of low electronic conductivity when electroactive material 2a has a low electronic conductivity. Accordingly, according to certain embodiments, there is a non-uniform distribution of the electronic conductivity in base layer 2. In the base structure shown in FIG. 1C, base layer 2 exhibits an external surface exposing particulate electroactive material 2a. Due to the large particle size of particulate electroactive material 2a, external surface 200 of the base layer exhibits distinct valleys and peaks (and, accordingly, relatively high surface roughness Rz). In the layer composite according to FIG. 1B, particulate electroactive material 1a of portion 1 at least partially covers and fills said valleys and covers said peaks, thus creating an external surface 100 having a lower surface roughness Rz compared to external surface 200 of the base layer in the base structure. Moreover, in the embodiment shown in FIG. 1B, the small particle size of the electroactive material 1a reduces the extensions of domains of low electronic conductivity and allows for a more uniform distribution of electronically conductive material 1b in portion 1, compared to the distribution of the electronically conductive material 2a in base layer 2.

In certain embodiments, the base layer (e.g., base layer 2 in FIGS. 1A-1D) comprises or consists of:
80 to 98% by weight of an electroactive material
1 to 15% by weight of an electronically conducting material (e.g., selected from the group consisting of graphite, carbon, graphene, and mixtures thereof)
1 to 15% by weight of a binding agent
   in each case referred to the total weight of said base layer.

In some embodiments, the portion disposed on the base layer (e.g., portion 1 in FIGS. 1A and 1B) comprises or consists of
80 to 98% by weight of an electroactive material
1 to 15% by weight of an electronically conducting material (e.g., selected from the group consisting of graphite, carbon, graphene, and mixtures thereof)
1 to 15% by weight of a binding agent 1c,
   in each case referred to the total weight of the portion disposed on the base layer.

In some embodiments, the portion disposed on the base layer (e.g., a single layer portion) comprises a functional material in the form of a particulate electronically conductive material (e.g., in the form of flat particles), and no electroactive material. In some such embodiments, said portion comprises or consists of
70 to 98% by weight of an electronically conducting material (e.g., selected from the group consisting of graphite, carbon, graphene, and mixtures thereof, in some embodiments comprising flat particles)
2 to 30% by weight of a binding agent in each case referred to the total weight of the portion disposed on the base layer.

FIG. 1D shows another layer composite, according to certain embodiments. In FIG. 1D, the layer composite comprises current collector 3. The layer composite of FIG. 1D also comprises base layer 2 in contact with current collector 3. Base layer 2 can comprise a particulate electroactive material (not shown in FIG. 1D for purposes of clarity). In FIG. 1D, the layer composite includes two-layered portion 1 disposed on base layer 2. Two-layered portion 1 consists of first layer 1a disposed on base layer 2 and second layer 1b disposed on first layer 1a. According to certain embodiments, at least one of said first layer and said second layer comprises a functional material (not shown in FIG. 1D, for purposes of clarity). In FIG. 1D, said second layer 1b has external surface 101 facing away from base layer 2. In some embodiments, the surface roughness Rz of external surface 101 is 5 μm or less. Examples of suitable functional materials are described, for example, above. In some embodiments, first layer 1a and second layer 1b each comprise a functional material having a structure different from the structure of the particulate electroactive material in base layer 2. In some embodiments, said functional materials in said first and second layer of said portion differ from each other in structure and/or chemical composition. Suitable functional materials are described, for example, above.

In certain embodiments, a layer composite according to FIGS. 1A, 1B and/or 1D has a total thickness of 1 mm or less (and, in some embodiments, 150 μm or less, or 100 μm or less). In some embodiments, the thickness of portion 1 (irrespective of the number of layers included in said portion) disposed on base layer 2 is in the range of from 50 nm to 50 μm, from 100 nm to 10 μm, or from 3 μm to 5 μm.

In the layer composites shown in FIGS. 1A, 1B, and 1D, and in the base structure shown in FIG. 1C, the base layer is positioned over the current collector. Alternatively, the current collector can be integrated into a bulk of the base layer, according to certain embodiments.

U.S. Provisional Patent Application Ser. No. 62/250,962, filed Nov. 4, 2015 and entitled “Layer Composite and Electrode Having a Smooth Surface, and Associated Methods,” is incorporated herein by reference in its entirety for all purposes.

The following examples are intended to illustrate certain embodiments of the present invention, but do not exemplify the full scope of the invention.

### Example 1

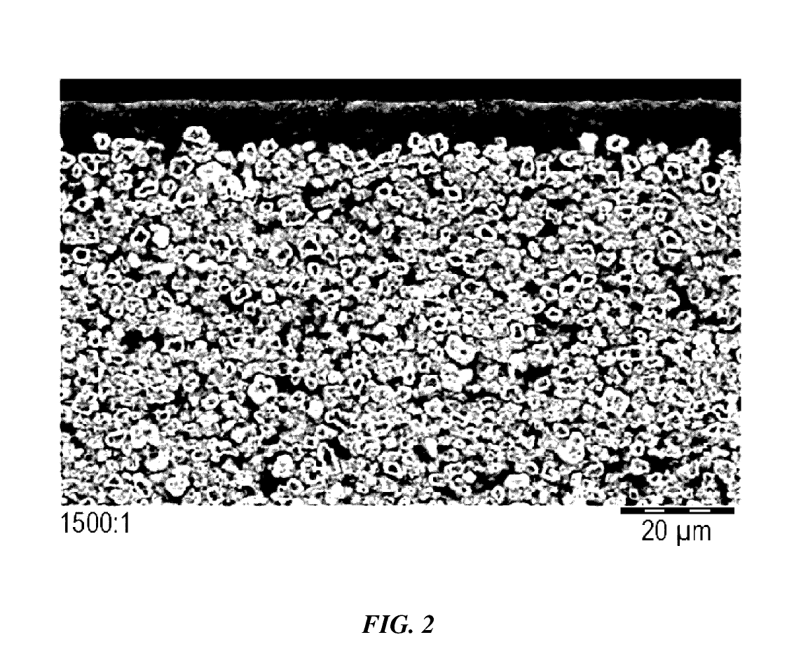

This example describes an exemplary layer composite incorporating features of certain of the embodiments described herein. FIG. 2 shows a SEM cross section pictograph of a base layer and a portion disposed over said base layer of the layer composite. The current collector is not shown. The portion shown in FIG. 2 comprises a base layer comprising a particulate electroactive material wherein the particles of said particulate material are large and coarse, and disposed on said base layer, a single-layered portion consisting of a single layer in contact with said base layer wherein said single layer comprises a particulate functional material selected from the group consisting of electroactive materials and electronically conductive materials, wherein the particles of said particulate functional material are small and fine, compared to the particles in said base layer. Moreover, it is seen that the small, fine particles of the particulate functional material of in the portion disposed on said base layer fill voids and/or depressions at the surface of the base layer.

In the specific example shown in FIG. 2, the particulate electroactive material in the base layer is lithium nickel cobalt manganese oxide having a mean maximum cross-sectional dimension of 4 μm. The single-layered portion disposed on said base layer comprises lithium-iron phosphate (i.e. an electroactive material) having a mean maximum cross-sectional dimension of 1.5 μm. The thickness of the base layer is 50 μm, and the thickness of the portion disposed on the base layer is 5 μm.

### Example 2

This example describes the manufacture of layered composites, according to certain embodiments.

Layer composites, in accordance with certain embodiments, were obtained by the following general method.

Base structures in the form of tapes comprising a current collector and a base layer in contact with said current collector were provided. The base layer comprised a particulate electroactive material. The current collector was an aluminum foil having a thickness of 20 μm. The base layer was positioned over the current collector by coating said current collector with a particulate electroactive material. Said base layer had a thickness of 50 μm. Said base layer had an external surface facing away from the aluminum foil. Said base layer comprised a particulate electroactive material (for further details see below).

Slurries were provided comprising one or more particulate functional materials (for further details, see below), polyvinylidene as the a binding agent, and M-ethylpyrrolidone as the carrier liquid.

Layer composites were obtained by disposing on said external surface of said base layer of the base structure the above-described slurry and forming said slurry into a portion disposed on said base layer, said portion having an external surface facing away from said base layer, wherein a surface roughness Rz of said external surface was 5 μm or less. The portion obtained in this way was a single-layered portion (e.g., as shown in FIGS. 1A and 1B).

Forming said portion comprised removal of the carrier liquid by drying and applying a force. Force was applied in a range of 1 N/mm to 600 N/mm (such as 200 N/mm to 300 N/mm) at a temperature in a range of 20° C. to 180° C. (such as 60° C. to 120° C.) to said surface of said base layer on which said composition was disposed. The force was applied by calandering.

The slurry as disposed on the base layer typically had a thickness of 10 μm to 20 μm. By drying and calandering, a single-layered portion having a thickness in the range of from 3 μm to 5 μm disposed on the base layer was formed from said slurry.

The obtained layer composites were in the form of tapes. Layer composites in the form of sheets suitable to be used as an electrode (e.g., as a lithium ion cathode) in an electrochemical cell were obtained by cutting, from said tapes, pieces of the desired size. Lithium ion cathodes including these structures are also referred to below as inventive cathodes.

### Example 3

This example describes the measurement and characterization of surface roughness, surface topography, and current distribution in exemplary layer composites.

Surface roughness parameters Ra, Rq, and Rz were measured using white light interferometry (a fast optical non-contact 3D metrology technique).

Ra is the arithmetic average height parameter. It is the most universally used roughness parameter for general quality control. It corresponds to the average absolute deviation of the roughness irregularities from the mean line over one sampling length.

Rq denotes the root mean square (RMS) as descriptor for the standard deviation of the distribution of surface heights. Rq is an important parameter to describe surface roughness by statistical methods. This parameter is more sensitive than Ra to large deviation from the mean line. The RMS mean line is the line that divides the profile so that the sum of the squares of the deviations of the profile height from it is equal to zero.

With regard to Rz, reference is made to the definition and description provided above.

The following layer composites were prepared, and the roughness parameters Ra, Rq and Rz of the external surfaces (facing away from the base layers) of the portions disposed on the base layers were measured:

(1) a layer composite wherein the base layer comprised lithium nickel cobalt manganese oxide (mean maximum cross-sectional dimension 4 μm) as the particulate electroactive material and wherein the portion disposed on the base layer consisted of a single layer comprising a functional material in the form of particulate graphite (flat particles having a mean maximum cross-sectional dimension of 3.5 μm)

(2) a layer composite wherein the base layer comprised lithium nickel cobalt manganese oxide (mean maximum cross-sectional dimension 13 μm) as the particulate electroactive material and wherein the portion disposed on the base layer consisted of a single layer comprising a functional material in the form of particulate graphite (flat particles having a mean maximum cross-sectional dimension of 3.5 μm)

(3) a layer composite wherein the base layer comprised lithium nickel cobalt manganese oxide (mean maximum cross-sectional dimension 4 μm) as the particulate electroactive material and wherein the portion disposed on the base layer consisted of a single layer comprising particulate lithium iron phosphate (mean maximum cross-sectional dimension 1 μm)

(4) a layer composite wherein the base layer comprised lithium nickel cobalt manganese oxide (mean maximum cross-sectional dimension 13 μm) as the particulate electroactive material and wherein the portion disposed on the base layer consisted of a single layer comprising a functional material in the form of particulate lithium iron phosphate (mean maximum cross-sectional dimension 1 μm).

The thickness of the portion disposed on the base layer was, in each case, in the range of from about 3 μm to about 5 μm. In layer composites (1) and (2), the flat graphite particles were oriented substantially parallel to the external surface of the portion disposed on the base layer. Mean maximum cross-sectional dimensions in each case were determined as described above.

For comparison, roughness parameters Ra, Rq and Rz of the external surfaces of the base layer (facing away from the current collector) were measured for the following base structures:

(5) a base structure wherein the base layer comprised lithium nickel cobalt manganese oxide (mean maximum cross-sectional dimension 13 μm) as the particulate electroactive material

(6) a base structure wherein the base layer comprised lithium nickel cobalt manganese oxide (mean maximum cross-sectional dimension 4 μm) as the particulate electroactive material.

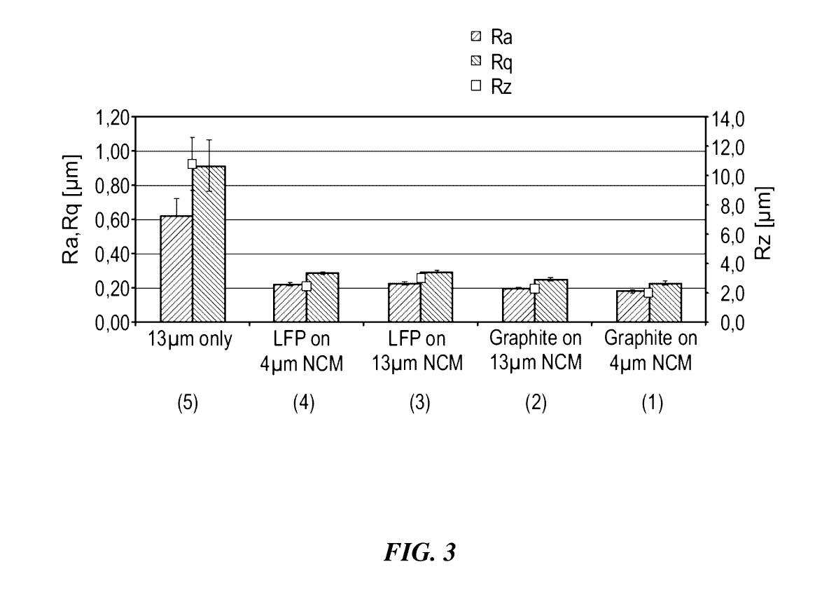

The results of the roughness measurements are shown in FIG. 3 (with the exception of base structure (6)). In the layer composites assembled according to certain inventive embodiments, the portions disposed on the base layers had external surfaces facing away from the base layer wherein the surface roughness Rz of said surface of said portion was substantially less than 5 μm (and even less than 4 μm, less than 3 μm, and less than 2 μm). With respect to layer composites (1) and (3), the surface roughness Rz of the external surface (facing away from the base layer) of the portion disposed on the base layer was significantly lower than the surface roughness Rz of the surface of the base layer (facing away from the current collector) of the corresponding base structure (5). On the other hand, the surface roughness Rz of the external surface of the base layer (facing away from the current collector) of the base structure (6) (not shown in FIG. 3) was similar to the surface roughness Rz of the external surfaces (facing away from the base layer) of the portions disposed on the base layers of layer composites (2) and (4). This was due to the fact that the mean maximum cross-sectional dimensions of the particulate electroactive materials in the base layers of layer composites (2) and (4) and base structure (6) were not significantly larger than the mean maximum cross-sectional dimensions of the graphite in the portion disposed on the base layer of layer composite (2) and of the lithium iron phosphate in layer composite (4).

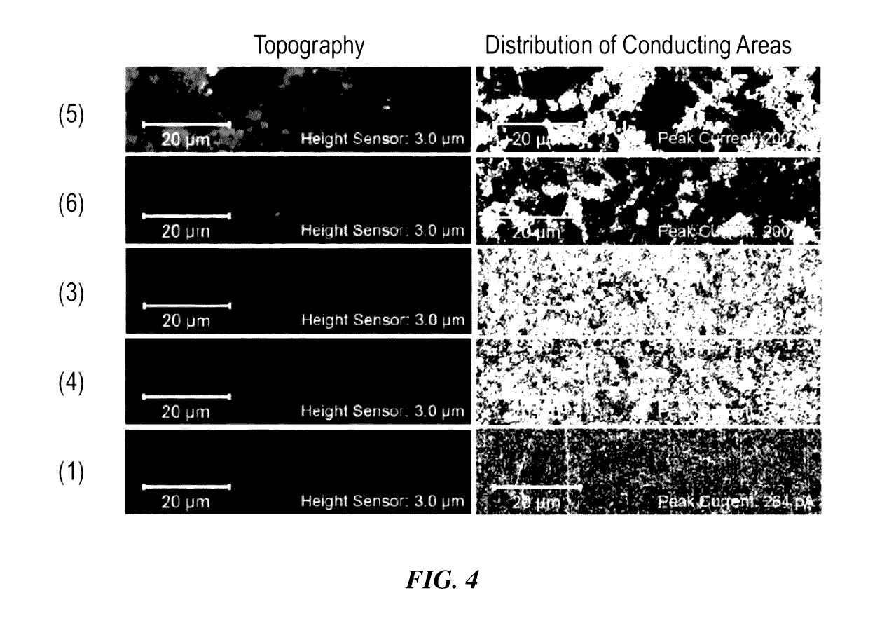

The layer composites (1), (3) and (4) as well as the base structures (5) and (6) were studied further by means of conductive AFM. The surface topography is shown in the left part of FIG. 4, and the distribution of electronically conducting areas (white) and electronically non-conducting areas (dark) in the right part of FIG. 4. It can be seen that the layer composites according to certain inventive embodiments had a smoother and finer surface topography as well as a more even distribution of electronically conducting areas (white) over the surface area. The size of electronically non-conducting areas (dark) was significantly smaller, compared to the external surfaces of the base layers of the structures (5) and (6) where the particulate electroactive material of the base layer was exposed.

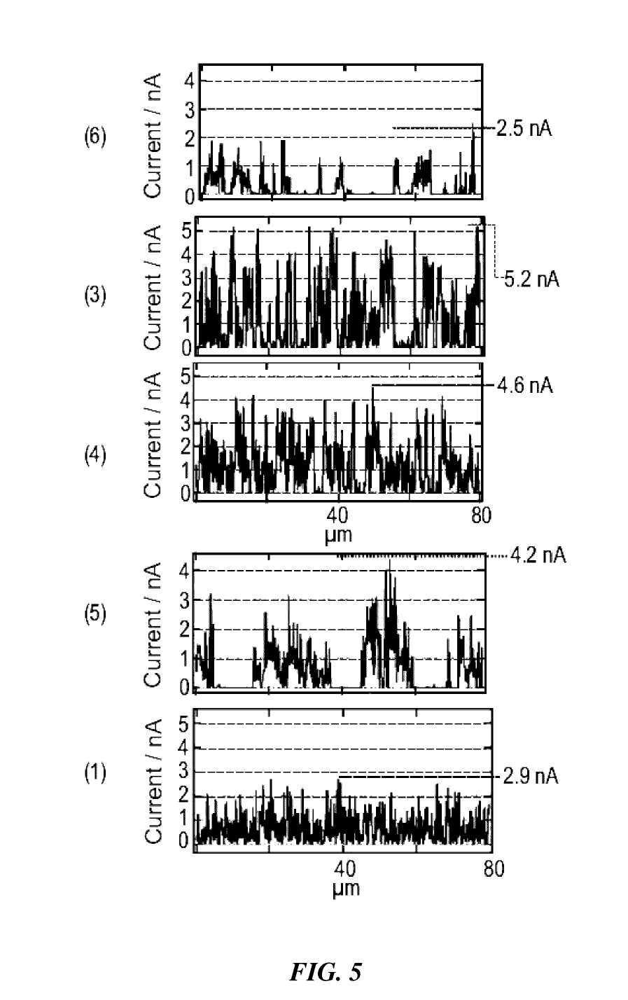

FIG. 5 shows the distribution of current peaks along a distance of 80 μm on the surfaces of layer composites according to certain inventive embodiments, and the corresponding base structures. Both base structures (5) and (6) show few current peaks with broad gaps between said current peaks. Layer composites (2), (3), and (4) each show a remarkably increased number of current peaks along the same distance wherein the current peaks are separated by very small gaps. Interestingly, an improved uniformity of the current distribution was obtained with layer composite (2), wherein the functional material was particulate graphite (i.e. an electronically conductive material) as well as with layer composites (3) and (4) wherein the functional material was particulate lithium iron phosphate (i.e. an electroactive material). The somewhat lower current measured at layer composite (2) was probably due to the anisotropic conductivity in the flat graphite particles (due to the layered structure of graphite, the in plane conductivity is significantly higher than the through-plane conductivity).

Further layer composites according to certain embodiments were prepared and the roughness parameters Ra, Rq, and Rz of the external surfaces (facing away from the base layer) of the portions disposed on the base layers were measured:

(7) a layer composite wherein the base layer comprises lithium nickel cobalt manganese oxide (mean maximum cross-sectional dimension 13 μm) as the particulate electroactive material and wherein the portion disposed on the base layer consists of a single layer comprising particulate lithium iron phosphate (mean maximum cross-sectional dimension 1 μm, supplier: BASF);

(8) a layer composite wherein the base layer comprises lithium nickel cobalt manganese oxide (mean maximum cross-sectional dimension 13 μm) as the particulate electroactive material and wherein the portion disposed on the base layer consists of a single layer comprising a functional material in the form of particulate lithium iron phosphate (mean maximum cross-sectional dimension 1 μm, supplier: Electrodes and More).

For comparison, roughness parameters Ra, Rq, and Rz of the external surface of the base layer (facing away from the current collector) of the base structure of layer composites (7) and (8) were measured. Said base structure was as follows:

(9) a base structure wherein the base layer comprises lithium nickel cobalt manganese oxide (mean maximum cross-sectional dimension 13 μm) as the particulate electroactive material.

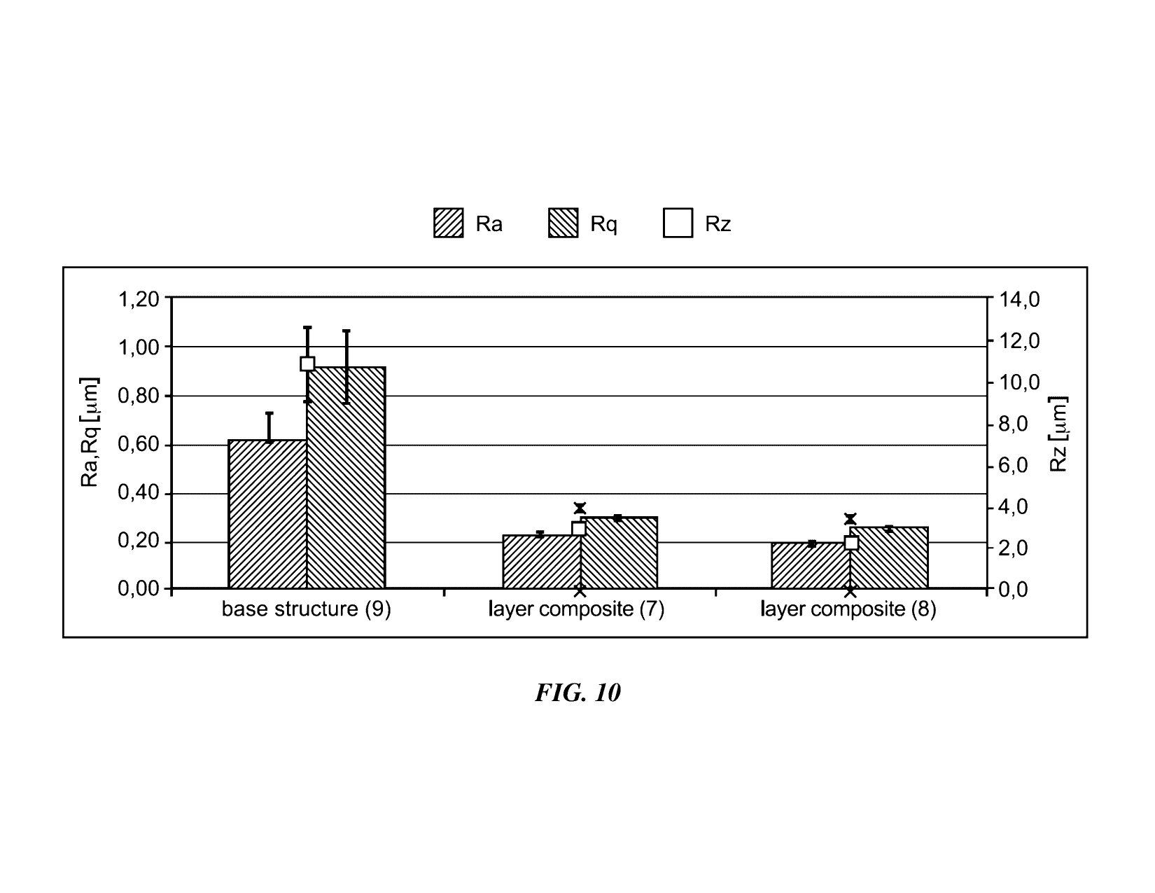

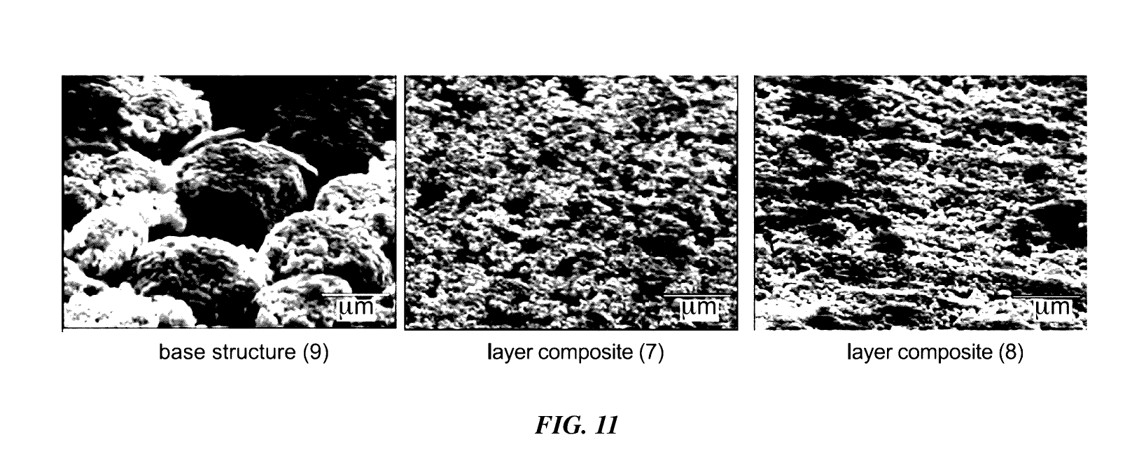

The results of the roughness measurements are shown in FIG. 10. In layer composites (7) and (8) according to certain embodiments, the portion disposed on the base layer had an external surface facing away from the base layer wherein the surface roughness Rz of said surface of said portion was substantially less than 5 μm, more specifically less than 4 μm, or even less than 3 μm, while the surface roughness Rz of the external surface of the base layer (facing away from the current collector) of the corresponding base structure (9) was substantially more than 7 μm, more specifically more than 10 μm.

The SEM images (FIG. 11) of the external surfaces of layer composites (7) (central part of FIG. 11) and (8) (right part of FIG. 11) according to certain embodiments and the corresponding base structure (9) (left part of FIG. 11) show that the external surface of each layer composite (7) and (8) was much smoother than that the external surface of base structure (9).

These results show that the goals of providing an external surface having a surface roughness Rz of 5 μm or less and providing an even distribution of electronically conducting areas can be met, for example, when the functional material is a particulate electroactive material having a maximum cross-sectional dimension which is 50% or less of the mean maximum cross-sectional dimension of the electroactive material in the base layer as well as when the functional material is an electronically conductive material comprising flat particles (as defined above).

### Example 4

This example describes the performance of lithium plating testing on exemplary layer composites.

A lithium ion cathode (herein referred to as the inventive cathode) consisting of a layer composite prepared as described above in which the base layer comprised lithium nickel cobalt manganese oxide (mean maximum cross-sectional dimension 13 μm) as the particulate electroactive material and wherein said portion disposed on the base layer consisted of a single layer comprising particulate lithium iron phosphate (mean maximum cross-sectional dimension 1.5 μm) as the functional material was charged using a copper foil as the counter electrode. The electrolyte was 1 M LiPF₆ dissolved in 1:1 (weight ratio) mixture of ethylene carbonate and dimethyl carbonate. The charging was done with a current density of 3.62 mA/cm². The total charge capacity was 0.1 mAh.

For comparison, a lithium ion cathode consisting of the above-described base structure wherein the base layer comprised lithium nickel cobalt manganese oxide (mean maximum cross-sectional dimension 13 μm) as the particulate electroactive material without any additional layers disposed on the base layer (herein referred to as the comparison cathode) was subjected to the same conditions.

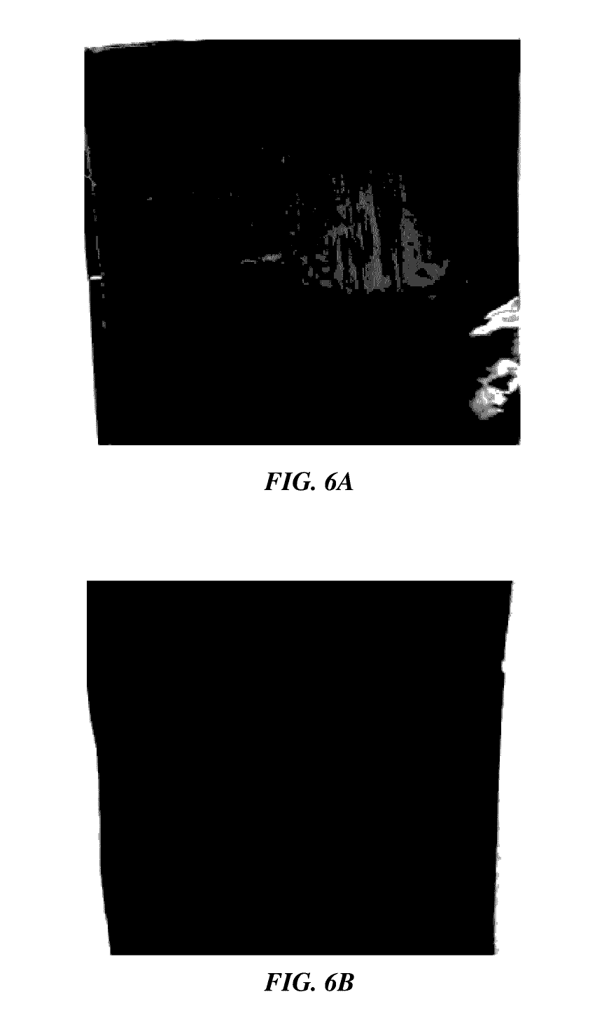

During charging, both cathodes released lithium ions which were reduced at the copper foil, resulting in the deposition of lithium metal. With the inventive cathode, the lithium plated on the copper foil exhibited a more smooth structure (FIG. 6b) and homogeneous distribution, compared to lithium plated on the copper foil serving as a counter electrode for a comparison cathode (FIG. 6a). Thus, the inventive cathode exhibited a significantly more uniform current distribution, compared to the comparison cathode.

### Example 5

This example describes electrochemical cell tests in which anodes comprising lithium metal were used as counter electrodes.

Electrochemical test cells (2) to (5) comprising a layer structure comprising an inventive cathode, a separator, and an anode comprising metallic lithium were assembled into a layered structure anode/separator/cathode. The total active cathode surface area was 16.5735 cm². After sealing each layered structure in a foil pouch, 0.3 mL of electrolytes was added.

The cell package was then vacuum sealed. These cells were allowed to soak in the electrolyte for 24 hours in an unrestrained state and then a force defining a pressure of 10 kg/cm² was applied. All cells were cycled under such force. Charge and discharge cycling was performed at Standard C/8 and C/5 rates, respectively, with charge cutoff voltage of 4.2 V followed by taper at 4.2 V to 0.5 mA, and discharge cutoff at 3.2 V.

For comparison, a cell (1) comprising a comparison cathode (as described above in Example 5) instead of a cathode according to certain inventive embodiments was prepared and tested in the same manner.

The following cells were assembled and tested:

(1) a cell wherein the cathode was a comparison cathode wherein the base layer comprised lithium nickel cobalt manganese oxide (mean maximum cross-sectional dimension 13 μm) as the particulate electroactive material

(2) a cell wherein the cathode was an inventive cathode wherein the base layer comprised lithium nickel cobalt manganese oxide (mean maximum cross-sectional dimension 13 μm) as the particulate electroactive material and wherein the portion disposed on the base layer consisted of a single layer comprising a functional material in the form of particulate graphite (flat particles having mean maximum cross-sectional dimension of 3.5 μm)

(3) a cell wherein the cathode was an inventive cathode wherein the base layer comprised lithium nickel cobalt manganese oxide (mean maximum cross-sectional dimension 13 μm) as the particulate electroactive material and wherein the portion disposed on the base layer consisted of a single layer comprising a functional material in the form of particulate lithium nickel cobalt manganese oxide (mean maximum cross-sectional dimension 1.5 μm)

(4) a cell wherein the cathode was an inventive cathode wherein the base layer comprised lithium nickel cobalt manganese oxide (mean maximum cross-sectional dimension 13 μm) as the particulate electroactive material and wherein the portion disposed on the base layer consisted of a single layer comprising a functional material in the form of particulate lithium iron phosphate (mean maximum cross-sectional dimension 1 μm)

(5) a cell wherein the cathode is an inventive cathode wherein the base layer comprised lithium nickel cobalt manganese oxide (mean maximum cross-sectional dimension 4 μm) as the particulate electroactive material and wherein the portion disposed on the base layer consisted of a single layer comprising a functional material in the form of particulate lithium iron phosphate (mean maximum cross-sectional dimension 1 μm).

Cell (1) is herein referred to as comparison cell, cells (2), (3), (4) and (5) as inventive cells. The thickness of the portion disposed on the base layer was, in each case, in the range of from about 3 μm to about 5 μm.

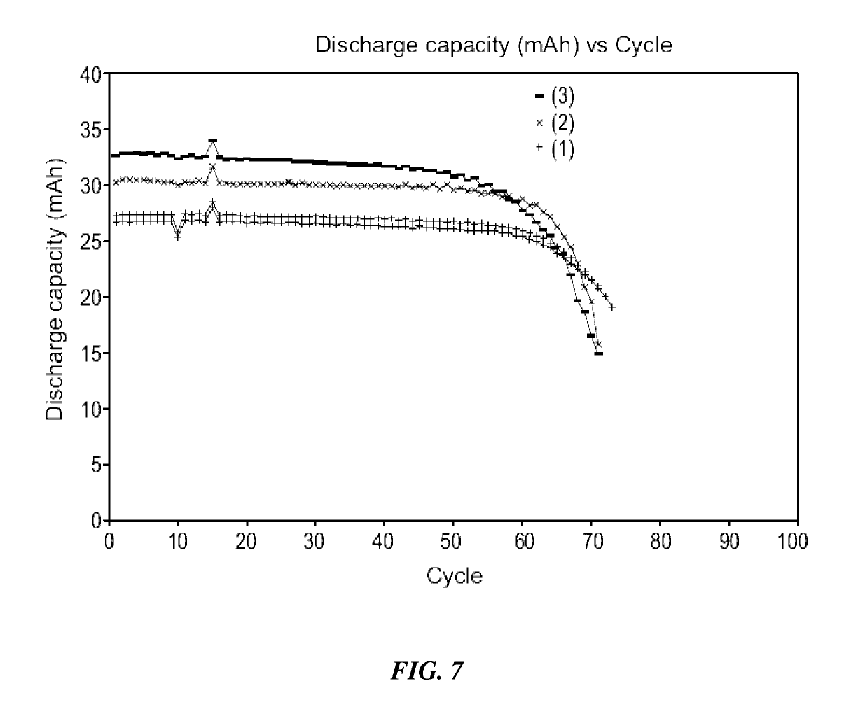

FIG. 7 shows the discharge capacity as a function of the cycle number for comparison cell (1) and inventive cells (2) and (3) (discharge rate C/5, electrolyte: is 1 M LiPF₆ dissolved in 1:1 (weight ratio) mixture of ethylene carbonate and dimethyl carbonate). All cells reached 80% of their initial capacity after a similar number of cycles (71 cycles in case of comparison cell (1), 63 resp. 67 in case of cells (2) and (3), resp.). However, inventive cells (2) and (3) had a higher initial discharge capacity, compared to comparison cell (1). This is attributed to improved plating and stripping of lithium at the anodes of the inventive cells (2) and (3).

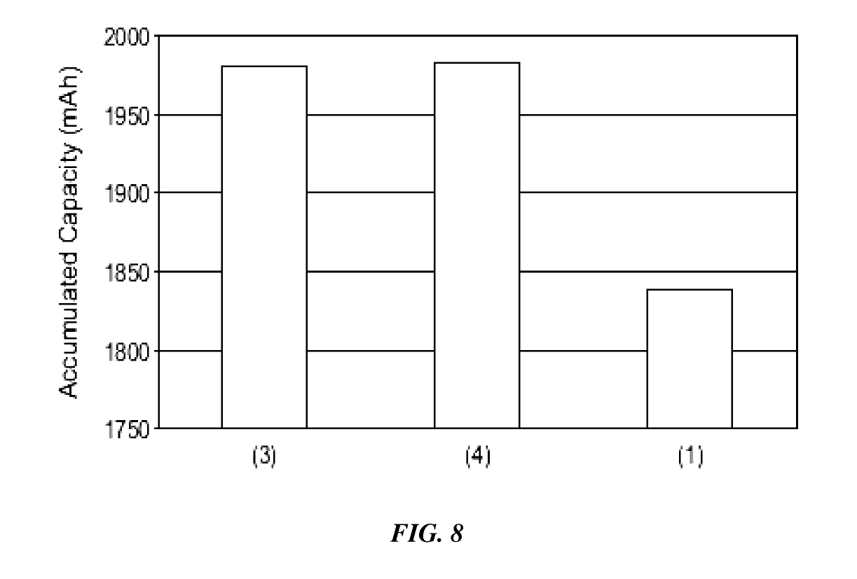

FIG. 8 shows the accumulated discharge capacity before reaching 80% of the initial discharge capacity for comparison cell (1) and inventive cells (2) and (4). In cells (2) and (4) the accumulated discharge capacity was about 8% higher, compared to comparison cell (1). This is attributed to improved plating and stripping of lithium at the anodes of inventive cells (2) and (4).

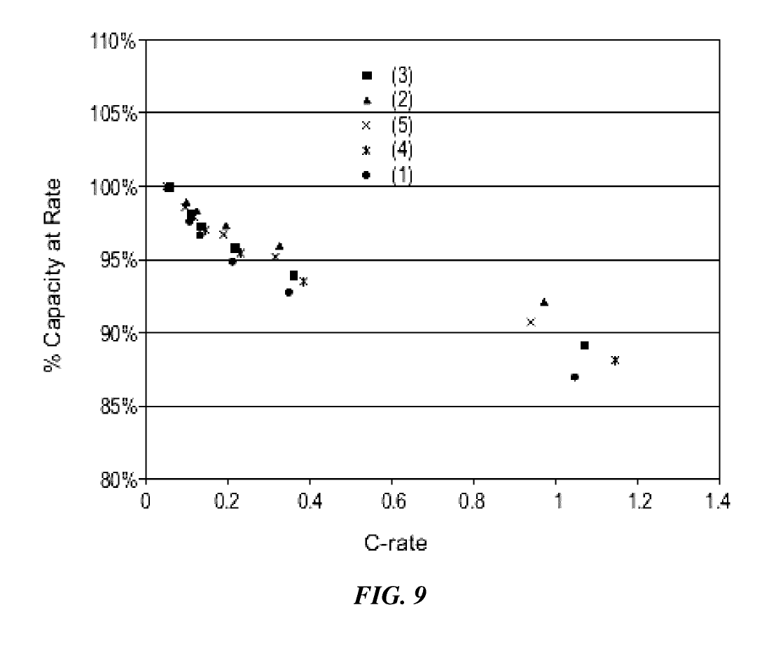

FIG. 9 shows the rate capability for comparison cell (1) and inventive cells (2), (3), (4) and (5). The rate capability for each cell was evaluated at the 15th discharge at rates of C, C/3, C/5, C/8, C/10 and C/20. The electrolyte was 1 M LiPF₆ dissolved in 1:1 (weight ratio) mixture of ethylene carbonate and dimethyl carbonate comprising 2 wt.-% suspended LiNO₃. No significant difference were found between comparison cell (1) and inventive cells (2), (3), (4) and (5). Accordingly, the additional layer in the cathodes of the inventive cells did not have a negative influence of the rate capability.

Further test cells (6) and (7) each comprising a cathode according to certain embodiments, a separator, and an anode comprising metallic lithium were assembled into a layered structure: anode/separator/cathode/separator/anode. For comparison, a comparison cell (8) comprising a comparison cathode (instead of a cathode according inventive embodiments) was prepared and tested in the same manner.

In each of cells (6)-(8), the anode was vacuum deposited lithium (thickness: 27 μm) on a polyethylene terephthalate (PET) substrate with a copper coating (thickness 200 nm) as a current collector. The separator was a porous polyolefin sheet having a thickness of 25 μm (supplier. Celgard 2325). The total active cathode surface area in each cell was 33.1 cm². After sealing the cell components in a foil pouch, 0.35 mL of electrolyte was added. The electrolyte used in each cell was LP30 (1M LiPF₆ dissolved in 1:1 (weight ratio) mixture of ethylene carbonate and dimethyl carbonate). The cell packages were then vacuum sealed. These cells were allowed to soak in the electrolyte for 24 hours unrestrained and then a pressure of 10 kg/cm² was applied. All cells were cycled under such pressure. Charge and discharge cycling was performed at standard C/8 and C/5 rates, respectively, for the first three cycles, and then C/3 charge and C discharge for subsequent cycles with charge cutoff voltage of 4.35 V followed by taper at 4.35 V to 0.5 mA, and discharge cutoff at 3.2 V.

The following cells were assembled and tested:

(6) a cell wherein the cathode is a cathode according to certain embodiments wherein the base layer comprises lithium nickel cobalt manganese oxide (mean maximum cross-sectional dimension 13 μm) as the particulate electroactive material and wherein the portion disposed on the base layer consists of a single layer comprising particulate lithium iron phosphate (mean maximum cross-sectional dimension 1 μm, supplier: BASF);

(7) a cell wherein the cathode is a cathode according to certain embodiments wherein the base layer comprises lithium nickel cobalt manganese oxide (mean maximum cross-sectional dimension 13 μm) as the particulate electroactive material and wherein the portion disposed on the base layer consists of a single layer comprising a functional material in the form of particulate lithium iron phosphate (mean maximum cross-sectional dimension 1 μm, supplier: Electrodes and More);

(8) a cell wherein the cathode is a comparison cathode wherein the base layer comprises lithium nickel cobalt manganese oxide (mean maximum cross-sectional dimension 13 μm) as the particulate electroactive material.

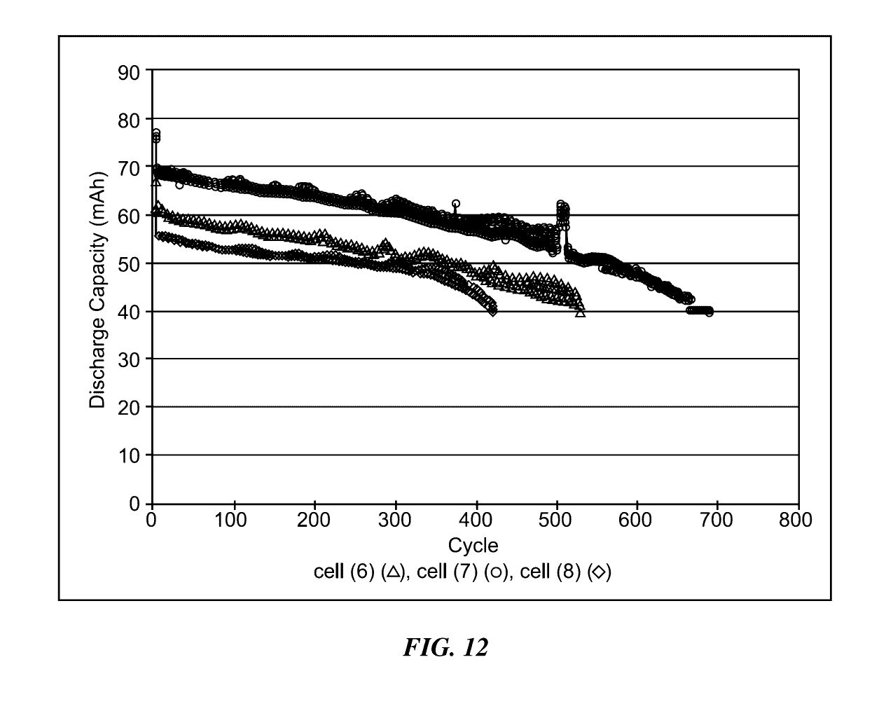

FIG. 12 shows the discharge capacity as a function of the cycle number for comparison cell (8) and cells (6) and (7) according to certain embodiments. Cells (6) and (7) showed significant improvement in cycle life: the average number of cycles until comparison cell (8) reached 80% of its initial capacity was 368, while cells (6) and (7) reached 80% of its initial capacity at 424 and 461 cycles, respectively, even though cells (6) and (7) were subject to cycling at higher capacity (due to the presence of additional electroactive material in the portion disposed on the base layer).

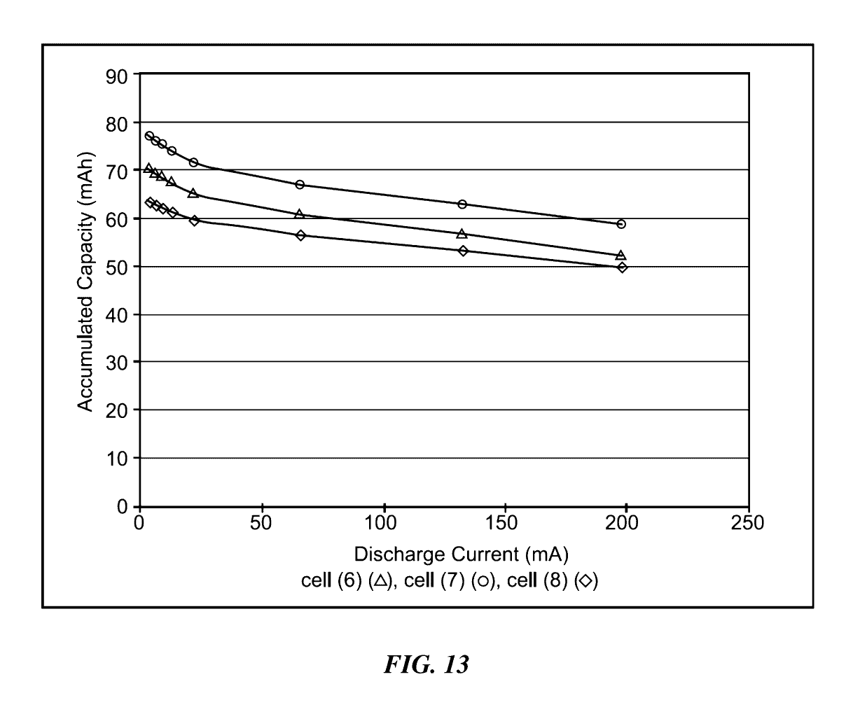

FIG. 13 shows the rate capability for comparison cell (8) and cells (6) and (7) according to certain embodiments. Rate capability was evaluated at the 15th discharge at a rate of 3C, 2C, C, C/3, C/5, C/8, C/10, and C/20. Cells (6) and (7) exhibited an enhanced rate capability, i.e., more capacity was delivered by each of cells (6) and (7) than by comparison cell (8) at the same discharge current.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A layer composite, comprising:
a current collector;
a base layer in contact with said current collector, said base layer comprising a particulate electroactive material; and
a portion disposed on said base layer, wherein said portion comprises a functional material having a structure different from a structure of the particulate electroactive material in the base layer, said functional material being selected from the group consisting of electronically conducting materials, electroactive materials, and mixtures thereof,
wherein said portion has an external surface facing away from the base layer, wherein the surface roughness Rz of said external surface of said portion is 5 μm or less.

2. A layer composite according to claim 1, wherein the base layer comprises a particulate electroactive material having a mean maximum cross-sectional dimension in the range of from 4 μm to 25 μm.

3. A layer composite according to claim 1, wherein the total thickness of said layer composite is 1 mm or less, and wherein the thickness of the portion disposed on said base layer is in the range of from 50 nm to 50 μm.

4. A layer composite according to claim 1, wherein said functional material is selected from the group consisting of electronically conductive materials.

5. A layer composite according to claim 1, wherein said functional material is selected from the group consisting of electroactive materials.

6. A layer composite according to claim 1, wherein said functional material is selected from the group consisting of mixtures of at least one electroactive material and at least one electronically conductive material.

7. A layer composite according to claim 1, wherein said functional material is a particulate material having a mean maximum cross-sectional dimension which is 50% or less of the mean maximum cross-sectional dimension of the particulate electroactive material in the base layer.

8. A layer composite according to claim 7, wherein said functional material is a particulate material having a mean maximum cross-sectional dimension in the range of from 30 nm to 4 μm.

9. A layer composite according to claim 1, wherein said functional material is a particulate material having a mean minimum cross-sectional dimension in the range of from 50 nm to 5 μm and a mean maximum cross-sectional dimension in the range of from 100 nm to 25 μm.

10. A layer composite according to claim 1, wherein said functional material has a structure comprising fused particles.

11. A layer composite according to claim 1, wherein said functional material has a monolithic structure.

12. A layer composite according to claim 1, wherein said functional material has an aggregated structure.

13. A layer composite according to claim 1, wherein said functional material has a polycrystalline structure.

14. A layer composite according to claim 1, wherein said portion disposed on said base layer consists of a single layer disposed on said base layer, said single layer comprising said functional material, wherein said single layer has an external surface facing away from the base layer, wherein the surface roughness Rz of said external surface of said single layer is 5 μm or less.

15. A layer composite according to claim 1, wherein said portion disposed on said base layer comprises a first layer disposed on said base layer and one or more additional layers disposed on said first layer wherein at least one of said first layer and said one or more additional layers comprises said functional material.

16. A layer composite according to claim 15, wherein said portion disposed on said base layer consists of a first layer disposed on said base layer and a second layer disposed on said first layer, wherein at least one of said first layer and said second layer comprises said functional material wherein said second layer has an external surface facing away from the base layer, wherein the surface roughness Rz of said external surface of said second layer is 5 μm or less.

17. A layer composite according to claim 16, wherein a thickness of said second layer is 50% or less of a thickness of said first layer.

18. A layer composite according to claim 15, wherein said first layer comprises said functional material.

19. A layer composite according to claim 15, wherein said first layer and at least one of said additional layers each comprise a functional material having a structure different from the structure of the particulate electroactive material in the base layer, wherein said functional materials differ from each other in structure and/or chemical composition.

20-62. (canceled)

63. A method for forming a layer composite, comprising:
disposing, on a base layer of a base structure comprising said base layer and a current collector in contact with said base layer, a portion comprising a functional material, wherein:
said base layer comprises a particulate electroactive material;
said functional material of said portion comprises an electronically conducting material, an electroactive material, and/or one or more precursors of an electronically conducting material and/or an electroactive material;
said functional material has a structure different from a structure of said particulate electroactive material in said base layer; and
said portion has an external surface facing away from said base layer, wherein a surface roughness Rz of said external surface of said portion is 5 μm or less.

64-78. (canceled)
